(19) United States
(12) Patent Application Publication
(10) Pub. No.: US 2026/0246522 A1
(43) Pub. Date: Aug. 20, 2026

(54) ENCODING OF A PRECODER FOR SPATIAL LAYER SIGNAL QUALITY EQUIVALENCE

(71) Applicant: QUALCOMM Incorporated, San Diego, CA (US)

(72) Inventors: Chih-Hao LIU, San Diego, CA (US); Yu ZHANG, San Diego, CA (US); Wei YANG, San Diego, CA (US); Tzu-Hsuan CHOU, San Diego, CA (US)

(21) Appl. No.: 19/058,204

(22) Filed: Feb. 20, 2025

(51) Int. Cl. H04B 7/06; H04W 24/10

(52) U.S. Cl. CPC H04B 7/0639; H04B 7/0626; H04W 24/10

(57) ABSTRACT

Various aspects of the present disclosure generally relate to wireless communication. In some aspects, a UE may receive, from a network node, one or more reference signals associated with measurement of a signal quality associated with a transmission channel. The UE may transmit, to the network node, a channel state information report that includes precoder information indicative of a geometric mean decomposition precoder associated with the transmission channel and includes first information associated with one or more Givens rotation matrices and second information associated with one or more permutation matrices. Numerous other aspects are described.

### INTRODUCTION

Aspects of the present disclosure generally relate to wireless communication and specifically relate to techniques, apparatuses, and methods associated with wireless message precoding.

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a user equipment (UE) for wireless communication. The UE may include one or more memories and one or more processors coupled to the one or more memories. The one or more processors may be configured to receive, from a network node, one or more reference signals associated with measurement of a signal quality associated with a transmission channel. The one or more processors may be configured to transmit, to the network node, a channel state information (CSI) report that includes precoder information indicative of a geometric mean decomposition (GMD) precoder associated with the transmission channel and includes first information associated with one or more Givens rotation matrices and second information associated with one or more permutation matrices.

Some aspects described herein relate to a network node for wireless communication. The network node may include one or more memories and one or more processors coupled to the one or more memories. The one or more processors may be configured to send one or more reference signals associated with measurement of a signal quality associated with a transmission channel. The one or more processors may be configured to obtain a CSI report that includes precoder information indicative of a GMD precoder associated with the transmission channel and includes first information associated with one or more Givens rotation matrices and second information associated with one or more permutation matrices.

Some aspects described herein relate to a method of wireless communication performed at a UE. The method may include receiving, from a network node, one or more reference signals associated with measurement of a signal quality associated with a transmission channel. The method may include transmitting, to the network node, a CSI report that includes precoder information indicative of a GMD precoder associated with the transmission channel and includes first information associated with one or more Givens rotation matrices and second information associated with one or more permutation matrices.

Some aspects described herein relate to a method of wireless communication performed at a network node. The method may include sending one or more reference signals associated with measurement of a signal quality associated with a transmission channel. The method may include obtaining a CSI report that includes precoder information indicative of a GMD precoder associated with the transmission channel and includes first information associated with one or more Givens rotation matrices and second information associated with one or more permutation matrices.

Some aspects described herein relate to a non-transitory computer-readable medium that stores a set of instructions for wireless communication by a one or more instructions that, when executed by one or more processors of a UE, may cause the UE to receive, from a network node, one or more reference signals associated with measurement of a signal quality associated with a transmission channel. The set of instructions, when executed by one or more processors of the UE, may cause the UE to transmit, to the network node, a CSI report that includes precoder information indicative of a GMD precoder associated with the transmission channel and includes first information associated with one or more Givens rotation matrices and second information associated with one or more permutation matrices.

Some aspects described herein relate to a non-transitory computer-readable medium that stores a set of instructions for wireless communication by a network node. The set of instructions, when executed by one or more processors of the network node, may cause the network node to send one or more reference signals associated with measurement of a signal quality associated with a transmission channel. The set of instructions, when executed by one or more processors of the network node, may cause the network node to obtain a CSI report that includes precoder information indicative of a GMD precoder associated with the transmission channel and includes first information associated with one or more Givens rotation matrices and second information associated with one or more permutation matrices.

Some aspects described herein relate to an apparatus for wireless communication. The apparatus may include means for receiving, from a network node, one or more reference signals associated with measurement of a signal quality associated with a transmission channel. The apparatus may include means for transmitting, to the network node, a CSI report that includes precoder information indicative of a GMD precoder associated with the transmission channel and includes first information associated with one or more Givens rotation matrices and second information associated with one or more permutation matrices.

Some aspects described herein relate to an apparatus for wireless communication. The apparatus may include means for sending one or more reference signals associated with measurement of a signal quality associated with a transmission channel. The apparatus may include means for obtaining a CSI report that includes precoder information indicative of a GMD precoder associated with the transmission channel and includes first information associated with one or more Givens rotation matrices and second information associated with one or more permutation matrices.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of wireless message precoding and demapping.

FIG. 4 is a diagram illustrating an example associated with efficient signaling of a geometric mean decomposition precoder.

FIG. 5 is a diagram illustrating an example associated with separate signaling for different types of precoders.

FIG. 6 is a diagram illustrating an example associated with encoding of a precoder for spatial layer signal quality equivalence.

FIG. 7 is a diagram illustrating an example process performed, for example, at a user equipment (UE) or an apparatus of a UE.

FIG. 8 is a diagram illustrating an example process performed, for example, at a network node or an apparatus of a network node.

FIG. 9 is a diagram of an example apparatus for wireless communication.

FIG. 10 is a diagram illustrating an example of a hardware implementation for an apparatus employing a processing system.

FIG. 11 is a diagram illustrating an example of an implementation of code and circuitry for an apparatus.

FIG. 12 is a diagram of an example apparatus for wireless communication.

FIG. 13 is a diagram illustrating an example of a hardware implementation for an apparatus employing a processing system.

FIG. 14 is a diagram illustrating an example of an implementation of code and circuitry for an apparatus.

FIG. 15 is a diagram illustrating an example associated with a set of permutation indexes.

### DETAILED DESCRIPTION

In some examples, a network node and a user equipment (UE) may communicate one or more uplink and downlink messages via a transmission channel. For example, a transmission channel may be a medium through which data is transferred between the UE and the network node. A transmission channel may include one or more of: physical channels that handle over-the-air data transfer, transport channels that manage how data is delivered between protocol layers, or logical channels that define the type of data being sent (e.g., control or user data). Additionally, a transmission channel may be associated with a frequency bandwidth part, which may be a range of frequencies over which wireless messages may be transmitted. In some examples, a frequency bandwidth part may include smaller divisions of the allocated frequency spectrum used for fine-grained resource management and reporting. For instance, the transmission channel may span a frequency bandwidth part that includes a first frequency subband that spans a first subset of frequencies of the frequency bandwidth part and a second frequency subband that spans a second subset of frequencies of the frequency bandwidth part. Additionally, a transmission channel may be associated with one or more spatial layers. For example, multiple spatial layers may represent independent data streams transmitted simultaneously using multiple antennas. Accordingly, multiple spatial layers of the transmission channel may be separated in a spatial domain (e.g., associated with different spatial directions).

In some examples, the network node or the UE may precode a wireless message before transmitting the wireless message via the transmission channel. For example, precoding a wireless message may be associated with applying a mathematical transformation (e.g., a precoding matrix) to one or more data streams associated with the one or more spatial layers of the transmission channel. Precoding may adjust the phase and amplitude of the signals for each antenna to improve signal quality for the one or more spatial streams.

In some examples, the network node and the UE may precode a wireless message using a singular value decomposition (SVD) precoder. For example, an SVD precoder may be a multiple-input multiple-output (MIMO) precoding technique that decomposes a channel matrix (e.g., a mathematical representation of the transmission channel) into orthogonal components, allowing the spatial layers of the transmission channel to align with the strongest eigenmodes of the transmission channel. In some examples, the eigenmodes of the transmission channel may represent a signal quality or signal strength associated with the spatial layers. In other words, applying an SVD precoder may independently increase the signal quality associated with each spatial layer.

In some other examples, the network node and the UE may precode a wireless message using a geometric mean decomposition (GMD) precoder. For example, a GMD precoder may be a MIMO precoding technique associated with balancing the signal quality across spatial layers of the transmission channel. In contrast to SVD precoding, which can result in uneven signal-to-noise ratios (SNRs) across the spatial layers, GMD precoding may enable the spatial layers to have nearly identical SNRs (e.g., the difference between a first SNR of a first spatial layer and a second SNR of a second spatial layer satisfies a difference tolerance threshold). In some examples, the GMD precoder may be deconstructed into one or more Givens rotation matrices and one or more permutation matrices that are indicative of the GMD. For example, a Givens rotation matrix may be a square matrix used to perform rotations in a specific plane of a multidimensional space. Additionally, a permutation matrix may be a square matrix used to rearrange the columns of an associated Givens rotation matrix. Accordingly, a GMD precoder may be represented by the product of a sequence of pairs of a Givens rotation matrix post-multiplied by a permutation matrix.

In some examples, the network node and the UE may precode a wireless message using a uniform channel decomposition (UCD) precoder. For example, a UCD precoder may be a MIMO precoding technique that decomposes the transmission channel into parallel subchannels with equal capacities. Additionally, and similar to the GMD precoder, the UCD precoder may balance the SNRs across spatial layers by allocating power and adjusting the precoding matrix. In some examples, a UCD precoder may be the product of an SVD precoder, a power loading matrix, and a GMD precoder. A power loading matrix may be a diagonal water-filling matrix, associated with MIMO systems, to increase power allocation across multiple spatial layers of the transmission channel. For instance, the power loading matrix may diagonally allocate power independently to each spatial layer of the transmission channel, where the values on the diagonal of the power loading matrix may represent the allocated power levels.

In some examples, the network node and the UE may determine a UCD precoder to apply to the transmission channel in accordance with a channel state information (CSI) procedure. For example, as part of the CSI procedure, the network node may send, and the UE may receive, one or more reference signals (such as CSI reference signals (CSI-RSs)) via the transmission channel. Accordingly, the UE may measure the one or more reference signals to generate the SVD precoder, the power loading matrix, and the GMD precoder that may result in a UCD precoder for the transmission channel. Additionally, the UE may determine a rank indicator (RI) and a channel quality indicator (CQI) based on measuring the one or more reference signals. In some examples, the UE may transmit, and the network node may obtain, a CSI report that indicates one or more of the CQI, the RI, or precoder information indicative of the SVD precoder, the power loading matrix, and the GMD precoder associated with the UCD precoder. Therefore, the network node may use the precoder information to generate the UCD precoder to apply to downlink messages transmitted to the UE.

In some examples, however, different portions of the precoder information used to generate the UCD precoder may change at different rates over time. For example, in fast-fading communication environments (e.g., where transmission channel characteristics change over time based on relative motion between the network node and the UE, or on dynamic environmental factors) one or more channel gains that affect the GMD precoder may change relatively fast while the SVD precoder may change more slowly in time because of dependency on the directionality or geometry of the transmission channel. Therefore, if the precoder information includes updated information for both the GMD precoder and the SVD precoder, but the SVD precoder is still up to date, then the CSI report including SVD precoder information may be redundant, increasing signaling overhead without increasing the quality of the transmission channel. Additionally, direct quantization of the GMD precoder into a set of bits to include in the CSI report may be associated with an increase the number of bits to include in the CSI report, which may increase signal overhead.

To reduce a number of bits in the precoder information used to express the GMD precoder, the UE may decompose the GMD precoder into multiple matrices. In some examples, one or more of the multiple matrices may be constructed from a single value (e.g., a rotational angle value) such that the UE may quantize the single value rather than an entire matrix. In some examples, one or more of the multiple matrices may point to different indexes of a table, such that the UE may indicate an index rather than quantize an entire matrix. Accordingly, the UE may decompose the GMD precoder into multiple matrices, where the indicating the information associated with the multiple matrices uses less bits in a CSI report compared to quantizing the GMD precoder.

Additionally, or alternatively, the UE may transmit two different CSI reports with two different periodicities. For example, the UE may transmit a first CSI report that includes information associated for updating the GMD precoder and a second CSI report that includes information for updating the SVD precoder. In some examples, the UE may transmit the first CSI report more frequently than the second CSI report based on the GMD precoder becoming out of date faster than the SVD precoder. Accordingly, the network node may receive the first and second CSI reports to construct the UCD precoder using the GMD precoder information and the SVD precoder information, where the GMD precoder information may be updated at a faster rate to account for temporal changes in channel gains.

Various aspects relate generally to efficient encoding of the precoder information as part of the CSI reporting. Some aspects relate to the UE transmitting a first CSI report that includes GMD precoder information indicative of the GMD precoder associated with the transmission channel. For example, the GMD precoder information may include first information associated with one or more Givens rotation matrices and second information associated with one or more permutation matrices, where the one or more Givens rotation matrices and the one or more permutation matrices may represent the GMD precoder. In some examples, the first information may include one or more rotation angle values that indicate the one or more Givens rotation matrices. For example, a rotational angle value of the one or more rotational angle values indicates an angle of rotation by which an associated Givens rotation matrix rotates a specific plane. Therefore, the first information may include a set of bits that indicates a rotational angle value, and the rotational angle value may be used to generate the associated Givens rotation matrix.

In some examples, a permutation matrix of the one or more permutation matrices may be associated with an index from a set of permutation indexes, where the second information may indicate the index associated with the permutation matrix. For example, the set of permutation indexes may be respectively associated with a set of possible permutation matrices for a permutation matrix. Therefore, the second information may include a set of bits that indicates the index associated with the permutation matrix.

In some examples, different frequency subbands of the transmission channel may be associated with different GMD precoders. For example, a first frequency subband may be associated with a first GMD precoder that can be decomposed into a first Givens rotation matrix, and a first permutation matrix and a second frequency subband may be associated with a second GMD precoder that can be decomposed into a second Givens rotation matrix and a second permutation matrix. In some aspects, the first information of the first CSI report may include a first rotational angle value that is indicative of the first Givens rotation matrix for the first frequency subband, and a second rotational angle value that is indicative of the second Givens rotation matrix for the second frequency subband. Additionally, the second rotational angle value may be a differential rotation angle value, where a difference between the first rotational angle value and the differential rotation angle value indicates the rotational angle value used to generate the second Givens rotation matrix for the second frequency subband. In some aspects, the second information may include a first index that indicates the first permutation matrix for the first frequency subband. Additionally, the first index may include a codepoint (e.g., an additional bit) that indicates whether the second permutation matrix for the second frequency subband is the same as the first permutation matrix.

In some examples, the network node may transmit, and the UE may receive, configuration information that configures the first CSI report (that includes the GMD precoder information) and a second CSI report that includes SVD precoder information that is indicative of the SVD precoder associated with the UCD precoder. That is, the network node may configure the UE to transmit the GMD precoder information and the SVD precoder information in separate CSI reports. In some examples, the configuration information may configure a periodic transmission of the first CSI report using a first period and configure a periodic transmission of the second CSI report using a second period that is greater than the first period. Therefore, the network node may configure the UE to indicate updated GMD preorder information more frequently than updated SVD precoder information.

Particular aspects of the subject matter described in this disclosure can be implemented to reduce a number of bits used to indicate a GMD precoder. For example, a first number of bits used to indicate the one or more rotational values associated with the one or more Givens rotation matrices and used to indicate one or more indexes associated with one or more permutation matrices may be less than a second number of bits used to explicitly quantize the GMD precoder. Accordingly, the techniques described herein may reduce the payload size and signaling overhead associated with indicating a GMD precoder. Additionally, or alternatively, the described techniques may reduce the number of bits that indicate multiple GMD precoders respectively associated with multiple frequency subbands. For example, a first number of bits used to indicate a differential rotation angle value may be less than a second number of bits used to indicate a rotation angle value. Further, including a codepoint that indicates a permutation matrix is the same for a first frequency subband and a second frequency subband may reduce the number of bits for indicating multiple permutation matrices across multiple frequency subbands. Accordingly, the techniques described herein may reduce payload size and signaling overhead associated with indicating multiple GMD precoders. Additionally, or alternatively, the techniques may reduce signaling overhead associated with CSI reporting. For example, because temporal variations in SVD precoding change more slowly than temporal variations in GMD precoding, the UE may transmit the second CSI report less frequently than the first CSI report, which reduces signaling overhead.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

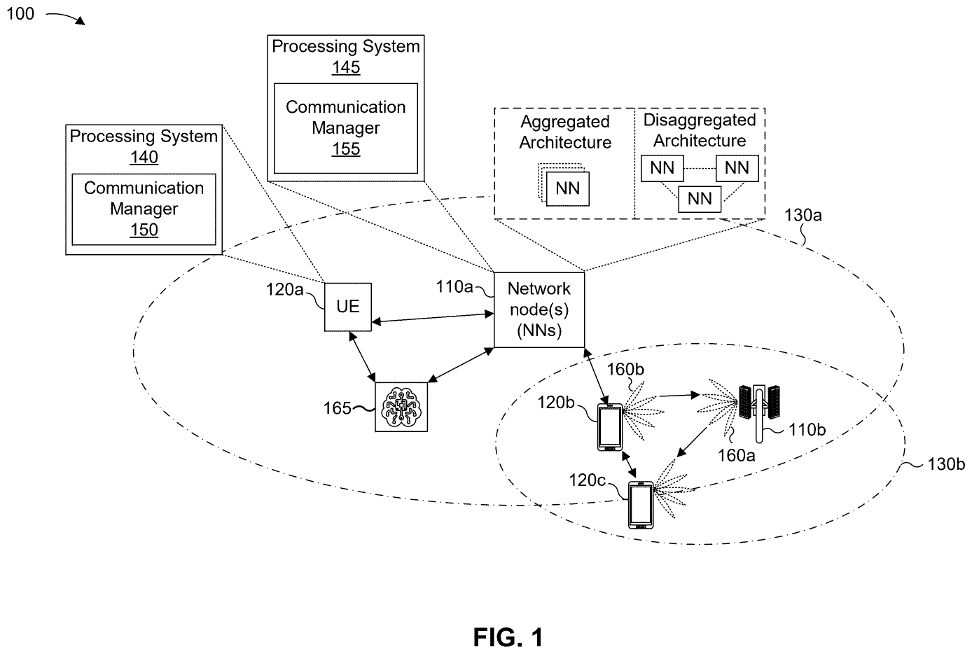

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)—reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node, one or more reference signals associated with measurement of a signal quality associated with a transmission channel; and transmit, to the network node, a channel state information (CSI) report that includes precoder information indicative of a geometric mean decomposition (GMD) precoder associated with the transmission channel and includes first information associated with one or more Givens rotation matrices and second information associated with one or more permutation matrices. Additionally, or alternatively, the communication manager 150 may perform one or more other operations described herein.

In some aspects, the network node 110 may include a communication manager 155. As described in more detail elsewhere herein, the communication manager 155 may send one or more reference signals associated with measurement of a signal quality associated with a transmission channel; and obtain a CSI report that includes precoder information indicative of a GMD precoder associated with the transmission channel and includes first information associated with one or more Givens rotation matrices and second information associated with one or more permutation matrices. Additionally, or alternatively, the communication manager 155 may perform one or more other operations described herein.

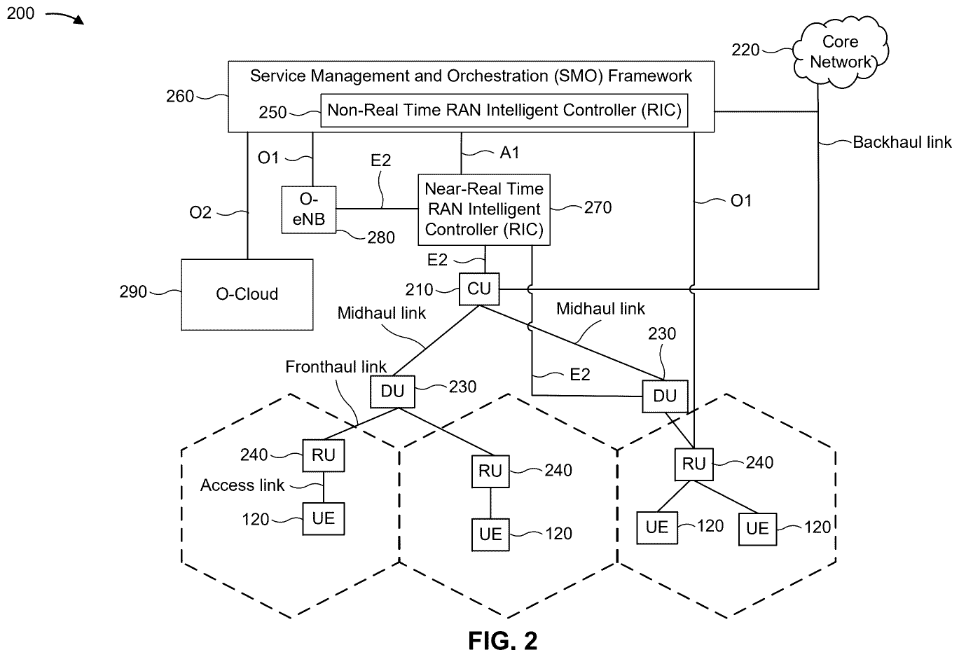

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

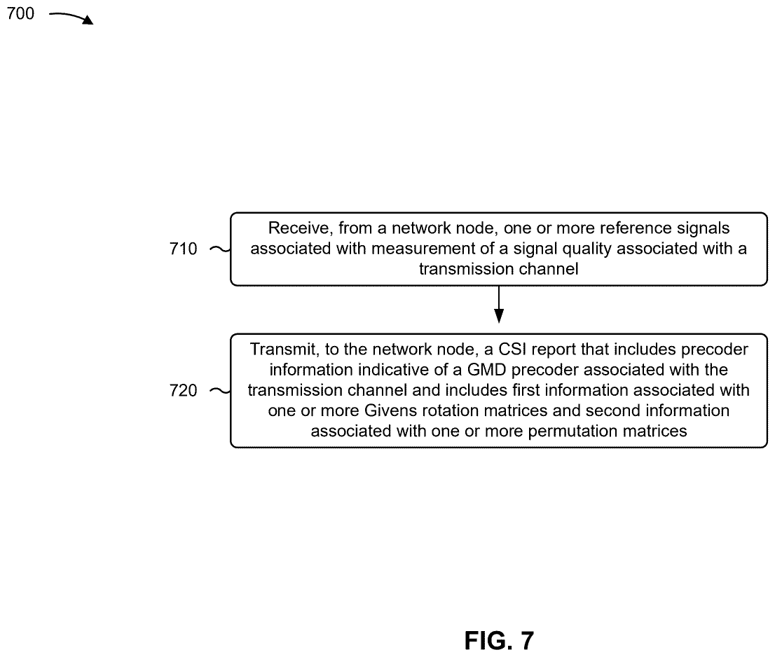

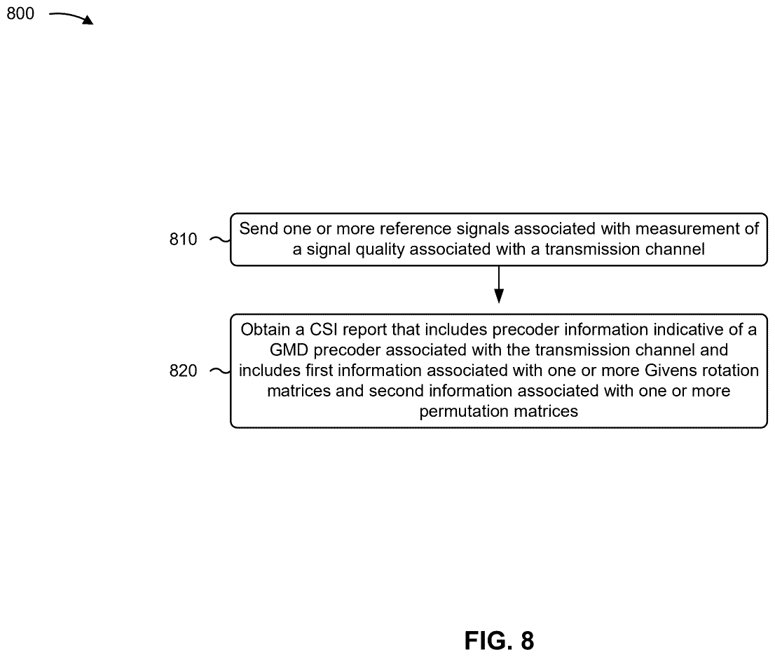

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with encoding of a precoder for spatial layer signal quality equivalence, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

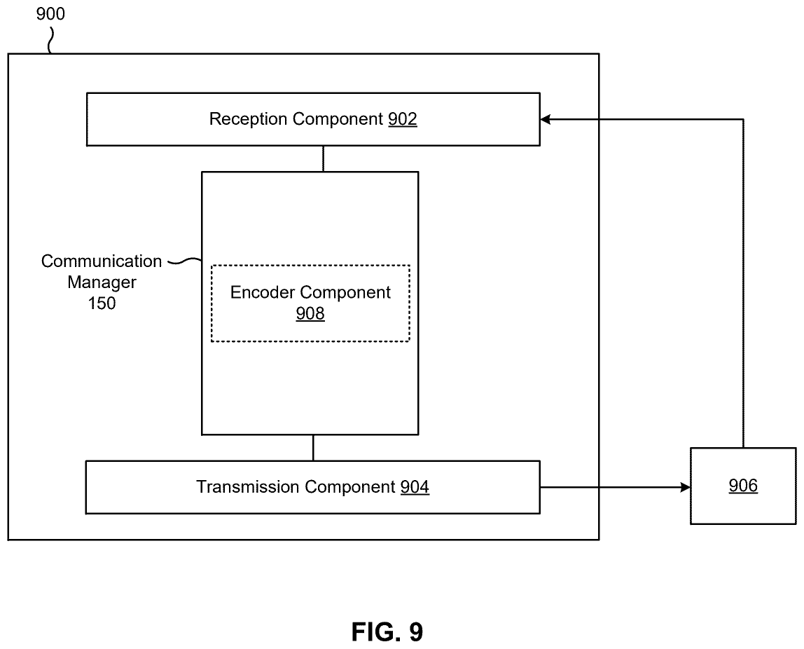

In some aspects, the UE 120 includes means for receiving, from a network node, one or more reference signals associated with measurement of a signal quality associated with a transmission channel; or means for transmitting, to the network node, a CSI report that includes precoder information indicative of a GMD precoder associated with the transmission channel and includes first information associated with one or more Givens rotation matrices and second information associated with one or more permutation matrices. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

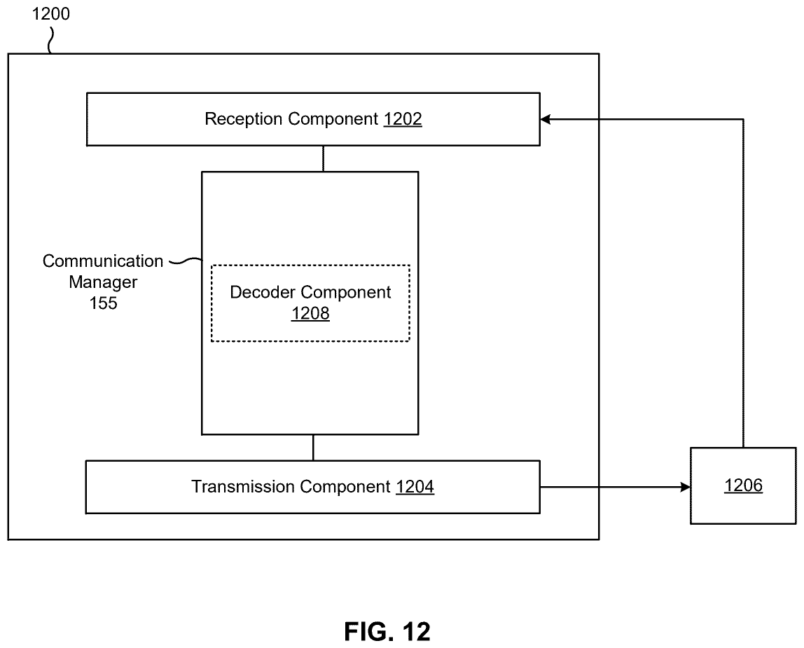

In some aspects, the network node 110 includes means for sending one or more reference signals associated with measurement of a signal quality associated with a transmission channel; or means for obtaining a CSI report that includes precoder information indicative of a GMD precoder associated with the transmission channel and includes first information associated with one or more Givens rotation matrices and second information associated with one or more permutation matrices. The means for the network node 110 to perform operations described herein may include, for example, one or more of communication manager 155, processing system 145, a radio, one or more RF chains, one or more transceivers, one or more antennas, one or more modems, a reception component (for example, a reception component (for example, reception component 1202 depicted and described in connection with FIG. 12), or a transmission component (for example, transmission component 1204 depicted and described in connection with FIG. 12), among other examples.

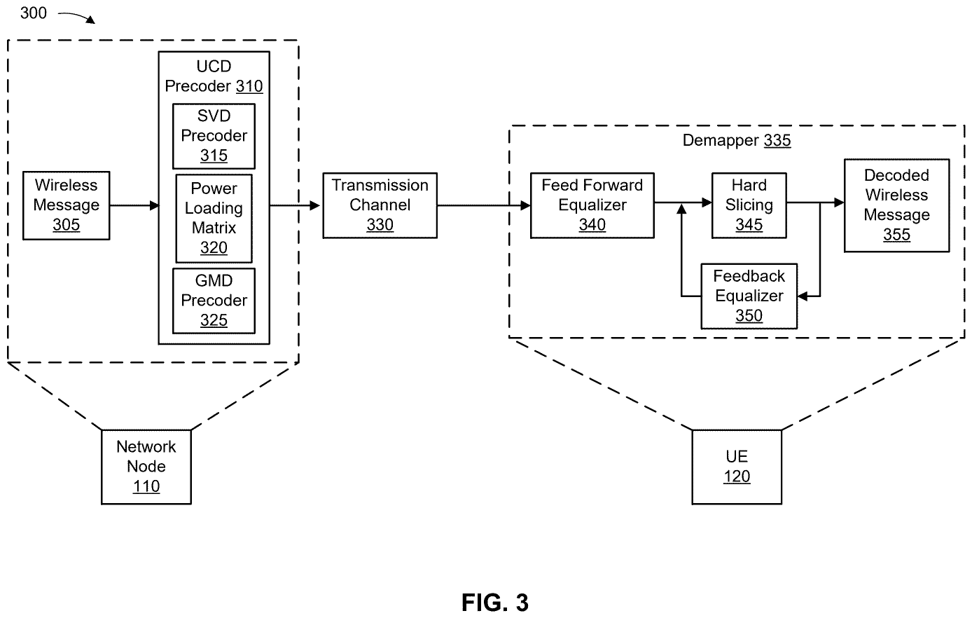

FIG. 3 is a diagram illustrating an example 300 of wireless message precoding and demapping. In some instances, example 300 may implement or be implemented by one or more aspects of FIGS. 1 and 2. For instance, FIG. 3 may illustrate wireless communications between the network node 110 and the UE 120.

In some examples, aspects of example 300 may support or be associated with MIMO precoding. For example, MIMO precoding may be categorized into codebook-based and non-codebook-based approaches. In some examples, codebook-based precoding may be associated with a predefined or preconfigured set of precoding matrices, or “codebooks” (e.g., defined in a wireless communications standard, such as 3GPP). Accordingly, the network node 110 may select a precoding matrix from the set of precoding matrices based on feedback from the UE 120. For instance, the UE 120 may transmit a CSI report that indicates a PMI, guiding the network node 110 in selecting the matrix that increases signal quality and reduces interference. Therefore, codebook-based MIMO precoding may increase computational efficiency at the network node 110 and the UE 120, and reduce signaling overhead based on leveraging the predefined set of precoding matrices. In contrast, non-codebook-based precoding may increase flexibility by enabling the network node 110 to compute precoding matrices dynamically, based on real-time channel state information. Therefore, non-codebook-based precoding may provide an increased adaptability to diverse and evolving channel environments but may increase computational complexity or signaling overhead.

In some examples, the network node 110 may use one or more of codebook-based or non-codebook-based MIMO precoding to transmit a codeword. For example, a codeword may be an encoded representation of a wireless message 305 (e.g., a transport block). The codeword may include original data bits and additional redundancy bits introduced during a channel coding process at the network node 110. In some examples, the codeword may be the unit of data transmission over the physical layer, which may enable robustness against channel impairments (such as noise or interference). Therefore, transmission of the codeword by the network node 110 enables the UE 120 to detect and correct errors, improving the reliability of communication.

In some examples, the network node 110 may transmit one or more codewords concurrently in MIMO systems, in accordance with a rank of transmission. For instance, transmission of one codeword may be supported if the number of associated layers (e.g., spatial layers or spatial streams) is less than or equal to four. Additionally, concurrent transmission of two codewords may be supported if the number of associated spatial layers is greater than four. In some examples, the number of concurrent codeword transmissions via a number of MIMO spatial layers may be based on or in accordance with a hardware implementation at the network node 110 or the UE 120. In some examples, any number of the codewords may be concurrently transmitted via any number of spatial layers.

In some examples, a set of MIMO spatial layers may be respectively associated with a set of signal quality values relative to a channel noise. With reference to example 300, signal quality of a spatial layer may be described with reference to signal-to-noise ratio (SNR). However, in other implementations of example 300, “signal quality” may refer to one or more other signal quality metrics, such as one or more of: reference signal received power (RSRP), reference signal received quality (RSRQ), signal-to-interference-plus-noise ratio (SINR), CQI, block error rate (BLER), bit error rate (BER), error vector magnitude (EVM), demodulation reference signal SINR (DMRS-SINR), or received signal strength indicator (RSSI).

In some examples, the channel coding process may be associated with a singular value decomposition (SVD) precoder 315. For example, SVD precoding may decompose the transmission channel 330 into a set of components that includes a first unitary matrix representing the network node 110 spatial directions, a diagonal matrix that includes values associated with channel gain for each spatial layer, and a second unitary matrix associated with the UE 120 spatial directions. The SVD decomposition may enable the network node 110 to precode data streams in alignment with a set of eigenmodes associated with a transmission channel 330 used for transmission. In some examples, aligning the precoded data streams with the set of eigenmodes may respectively increase the SNR across the set of spatial layers, which may result in a different SNR associated with each spatial layer.

In some examples, the transmission channel 330 may be the medium through which data may be transferred between the UE 120 and the network node 110. In other words, the transmission channel 330 may include the physical, transport, and logical channels that manage and transmit user data, control signaling, and system information. Physical channels, such as the physical downlink shared channel (PDSCH) and physical uplink shared channel (PUSCH), may handle the transmission over the air interface. Transport channels, such as the downlink shared channel (DL-SCH) and uplink shared channel (UL-SCH), may manage how data is delivered between the MAC and physical layers. Logical channels may define the type of data being sent, such as control or user data.

In accordance with codebook-based and non-codebook-based MIMO precoding, spatial layer SNR imbalance may reduce the quality of a codeword transmission. For example, in cases where a coding rate associated with transmission is above a coding rate threshold (e.g., a relatively high coding rate), decoding at the UE 120 may be relative to a spatial layer associated with the lowest SNR. In other words, decoding performance at the UE 120 may be limited by the lowest SNR across a set of MIMO spatial layers, which may reduce an ability of the UE 120 to decode the received codeword.

In some other examples, the channel coding process may be associated with a precoding procedure that enables equalizing signal quality across a set of MIMO spatial layers. For example, the network node 110 may use a UCD precoder 310 associated with balancing SNR across the set of MIMO spatial layers. For instance, one or more aspects of example 300 may be performed in accordance with UCD based precoding. In some examples, UCD based precoding is a technique used in MIMO systems to balance the performance of spatial layers for efficient data transmission. In some examples, UCD is associated with decomposing the transmission channel 330 into parallel subchannels with uniform capacities, which may enable each spatial layer to have comparable signal quality and reliability. This decomposition may allow the network node 110 to allocate data streams evenly across the spatial layers, increasing throughput while maintaining balanced performance. UCD may be particularly effective in scenarios where a difference in channel conditions across spatial layers is above a difference threshold, as UCD may mitigate the disparities in SNR by enabling each spatial layer to have a similar effective channel quality. By achieving uniformity in the channel capacity, UCD based precoding reduces the risk of weaker spatial layers (e.g., spatial layers associated with lower SNR values) dominating decoding performance.

In some examples, the UCD precoder 310 (F) may be associated with the SVD precoder 315 (Vₕ), a power loading matrix 320 (Σ_{f}), and a GMD precoder 325 (P), as described in Equation 1:

$$F = {V}_{h} {Σ}_{f} P \qquad ( 1 )$$

With reference to Equation 1, the SVD precoder 315 (Vₕ) may be associated with one or more vectors of the transmission channel 330. For example, the transmission channel 330 (H) may be described in Equation 2:

$$H = {W [ \begin{matrix}B & 0 \\ 0 & B\end{matrix} ]}^{H} , where B = [ {b}_{0} , … , {b}_{L - 1} ] and W = {U}_{w} {Σ}_{w} {V}_{w}^{H} \qquad ( 2 )$$

For example, B may include a set of discrete Fourier transform (DFT) bases bₗ=uₐ⊗v_{b}, where uₐ and v_{b} represent DFT vectors, and bₗ has dimensions

$$\frac{{P}_{CSIRS}}{2} \times 1 ( {P}_{CSIRS}$$

representing a number of CSI-RS ports associated with the transmission channel 330). Accordingly, the SVD precoder 315 (Vₕ) may be described in Equation 3:

$${V}_{h} = [ \begin{matrix}B & 0 \\ 0 & B\end{matrix} ] {V}_{w} \qquad ( 3 )$$

In some examples, V_{w} may be a semi-unitary matrix associated with the set of DFT bases (e.g., represented by B=[b₀, . . . , b_{L-1}]). Additionally, the matrix V_{w} may be associated with a set of measurements associated with one or more reference signals measured by the UE 120 via the transmission channel 330.

With reference to Equation 1, the power loading matrix 320 (Σ_{f}) may be an example of a diagonal water-filling matrix. For example, a diagonal water-filling matrix may be associated with MIMO systems, to increase power allocation across multiple spatial or frequency channels based on respective channel conditions. The diagonal water-filling matrix may diagonally allocate power independently to each spatial layer of the transmission channel 330, where the values on the diagonal of Σ_{f} represent the allocated power levels. In some examples, the UE 120 may generate the power loading matrix 320 (Σ_{f}) using a water-filling algorithm, where more power may be assigned to spatial layers with better conditions (e.g., higher SNRs), while less (or no) power may be allocated to weaker channels (e.g., lower SNRs). In some examples, the UE 120 may determine the diagonal entries of the power loading matrix 320 (Σ_{f}) in accordance with a difference between a “water level” (a threshold value) and the inverse of channel gains across the spatial layers of the transmission channel 330.

With reference to Equation 1, the GMD precoder 325 (P) may be associated with the network node 110 transforming the transmission channel 330 into a form that equalizes the SNR across multiple spatial layers, enabling balanced performance for all transmitted data streams. In some examples, the GMD precoding process may be associated with the network node 110 receiving a CSI report from the UE 120 (such as through uplink feedback or reference signal measurements). In accordance with one or more CSI parameters included in the CSI report, the network node 110 may perform a decomposition of the transmission channel 330 into components that represent the spatial characteristics transmission channel 330. Additionally, applying GMD may modify the decomposition such that each spatial layer experiences approximately the same effective SNR (e.g., the difference between the SNR of each spatial layer is less than a tolerance threshold). For example, if the number of spatial layers of the transmission channel 330 is three, and the effective SNR is equal to A, then a transmission channel 330 (H) associated with the transmission channel 330 may be in accordance with Equation 4:

$$H = [ \begin{matrix}\overline{λ} & 0 & 0 \\ 0 & \overline{λ} & 0 \\ 0 & 0 & \overline{λ}\end{matrix} ] \qquad ( 4 )$$

where the set of diagonal values of the transmission channel 330 (H) are respectively associated with the set of spatial layers of the transmission channel 330. That is, each column of the transmission channel 330 H may be associated with a respective stream of the transmission channel 330.

Additionally, determining the UCD precoder 310 applied to the transmission channel 330 may be associated with a decomposition of the transmission channel 330 (H) in accordance with Equation 5:

$$H = {QRP}^{H} = Q [ \begin{matrix}\overline{λ} & * & * \\ ⋮ & ⋱ & * \\ 0 & … & \overline{λ}\end{matrix} ] {P}^{H} \qquad ( 5 )$$

For example, matrix Q and matrix P may both be examples of a unitary matrix. In some examples, the matrix R may be an N×N matrix, where N is the number of spatial layers of the transmission channel 330. Additionally, the matrix R may be an upper triangular matrix, where each value across the diagonal of the matrix R is equal to A (e.g., the effective SNR for each spatial layer). Accordingly, the GMD precoder 325 (P) may be determined from the GMD decomposition using known matrices H, Q, and R. In some examples, one or more techniques described herein may interchange the GMD precoder 325 with a generalized triangle decomposition (GTD) precoder. For instance, a GTD procedure may be associated with decomposing the transmission channel 330 into a triangular matrix structure that facilitates pre-equalization and interference cancellation for multi-stream transmissions. Accordingly, GTD precoding may offer flexibility in balancing between interference suppression and sub-channel conditioning.

In some examples, the UE 120 may operate in accordance with a demapper 335 to decode the wireless message 305 that the network node 110 transmitted in accordance with GMD precoding. In example 300, the demapper 335 may be associated with decision feedback equalization (DFE) demapping. In accordance with DFE demapping, the UE 120 may decompose the transmission channel 330 using GMD or UCD techniques to balance the SNR across spatial layers (e.g., in accordance with matrix Q and matrix R (QR) decomposition, with reference to Equation 5). In some examples, as part of DFE demapping, the UE 120 may apply a feed forward equalizer 340 to the received signal. For example, the feed forward equalizer 340 (e.g., G) may be defined in accordance with Equation 6:

$$G = \frac{1}{\overline{λ}} {Q}^{H} \qquad ( 6 )$$

After applying the feed forward equalizer 340, the UE 120 may decode the spatial layers of the received signal sequentially. For example, the UE 120 may begin with decoding a first spatial layer of the transmission channel 330. The first spatial layer may be decoded in accordance with hard slicing 345. For example, the hard slicing 345 (in the context of demapping for UCD precoding) may include the process of directly mapping a received signal point in the QAM constellation to the nearest constellation symbol (e.g., without considering additional probabilistic or soft information about the signal). In QAM, each transmitted symbol may correspond to a specific point in the constellation, representing a combination of amplitude and phase. During the hard slicing 345, the UE 120 may use the demapper 335 to examine the location of the received signal for the first spatial layer in the complex plane and assign the location to the nearest valid symbol in the QAM constellation. In some examples, the hard slicing 345 may be computationally simple and fast compared to a process such as soft demapping, based on the hard slicing 345 not accounting for channel impairments such as noise or interference beyond QAM distance measurements. Additionally, in systems employing UCD or GMD precoding (where SNR across spatial layers is equalized), the reliability associated with hard slicing may be increased based on the balanced SNR reducing the probability of incorrect symbol decisions.

In accordance with decoding the data associated with the first spatial layer of the transmission channel 330, the UE 120 may use the decoded data to reconstruct and subtract the interference that the first spatial layer causes on the remaining spatial layers. For example, after decoding the data of the first spatial layer, the UE 120 may apply a feedback equalizer 350. The feedback equalizer 350 (e.g., B) may be defined in accordance with Equation 7:

$$B = ( \frac{1}{\overline{λ}} R - I ) \qquad ( 7 )$$

In accordance with applying feedback equalizer 350, the UE 120 may reduce the signal interference associated with the first spatial layer. Therefore, the UE 120 may continue with decoding the data associated with a second spatial layer of the transmission channel 330. For instance, the UE 120 may perform the hard slicing 345 for the second spatial layer and then apply the feedback equalizer 350 to reduce the signal interference associated with the second spatial layer. In some examples, as part of DFE demapping, the UE 120 may iteratively perform the hard slicing 345 and the feedback equalizer for each spatial layer of the transmission channel 330. Accordingly, the UE 120 may generate a decoded wireless message 355 in accordance with the demapper 335.

By leveraging UCD and GMD to equalize SNR across spatial layers, DFE demapping operates in a reduced error-prone environment, improving an effectiveness of DFE demapping. Additionally, the use of the feedback equalizer 350 in DFE demapping may allow the UE 120 to account for inter-spatial-layer dependencies dynamically. Additionally, UCD and GMD precoding may balance SNR across spatial layers of the transmission channel 330, which ensures that no single spatial layer dominates or becomes excessively weak, enhancing the overall reliability of the DFE demapping process. Therefore, the combination of UCD or GMD precoding and DFE demapping enables efficient and robust decoding of MIMO transmissions between the network node 110 and the UE 120.

In some examples, the UE 120 and the network node 110 may perform a CSI procedure to determine the UCD precoder 310 to apply to the transmission channel 330. For example, as part of the CSI procedure, the network node 110 may transmit, and the UE 120 may receive, one or more reference signals across the spatial layers of the transmission channel 330. Accordingly, the UE 120 may measure the one or more reference signals and determine the SVD precoder 315, the power loading matrix 320, and the GMD precoder 325 that, when combined to form the UCD precoder 310, balance the signal quality across the set of spatial layers of transmission channel 330. For instance, the UE 120 may determine or generate the SVD precoder 315, the power loading matrix 320, and the GMD precoder 325 in accordance with one or more of the techniques and equations described herein. Accordingly, the UE 120 may transmit, and the network node 110 may receive, one or more CSI reports that indicate the SVD precoder 315, the power loading matrix 320, and the GMD precoder 325, such that the network node 110 may generate the UCD precoder 310 for use in precoding one or more subsequent downlink transmissions. In some cases, however, the condition of the transmission channel 330 may be time varying. For example, the time varying transmission channel 330 (H (t)), may be described with reference to Equation 8:

$$H ( t ) = {U}_{h} ( t ) {\sum }_{h} ( t ) {V}_{h}^{H} ( t ) \qquad ( 8 )$$

In some examples, the GMD precoder 325 may be associated with or depend on Σₕ(t). Additionally, the temporal variations of the SVD precoder 315

$$( {V}_{h}^{H} ( t ) )$$

may be slower than temporal variations of Σₕ(t). For example, in fast-fading communication environments (e.g., where transmission channel characteristics change over time based on relative motion between the network node 110 and the UE 120, or on dynamic environmental factors) one or more channel gains in Eₕ(t) may change relatively fast while the singular vectors included in

$${V}_{h}^{H} ( t )$$

may change more slowly in time because of dependency on the directionality or geometry of the transmission channel 330. Therefore, for CSI reports indicating information for the UCD precoder 310, the GMD precoder 325 (which depends on Σₕ(t)) and the power loading matrix (which may be neglected if equal power allocation is assumed) may be updated more frequently compared to the SVD precoder 315. As described elsewhere herein, the UE 120 may transmit a first CSI report that indicates the GMD precoder 325 and optionally indicates the power loading matrix 320 in accordance with a first periodicity. Additionally, the UE 120 may transmit a second CSI report that indicates the SVD precoder 315 in accordance with a second periodicity that is less than the first periodicity.

In some examples, the UE 120 may indicate GMD precoder 325 via direct quantization of the matrix (P). For example, “direct quantization” may refer to a process of the UE 120 converting the continuous-valued entries of the matrix (P) into discrete values (quantization) in a way that makes the matrix (P) suitable for transmission over a wireless communication channel. However, the transmission channel 330 may include multiple frequency subbands respectively associated with multiple matrices (P). Therefore, direct quantization of multiple matrices may increase the number of bits to include in the first CSI report, which may increase signal overhead. As described elsewhere herein, the UE 120 may decompose a matrix (P) into one or more Givens rotation matrices and one or more permutation matrices to reduce the number of bits associated with indicating the matrix (P).

As indicated above, FIG. 3 is provided as an example. Other examples may differ from what is described with regard to FIG. 3.

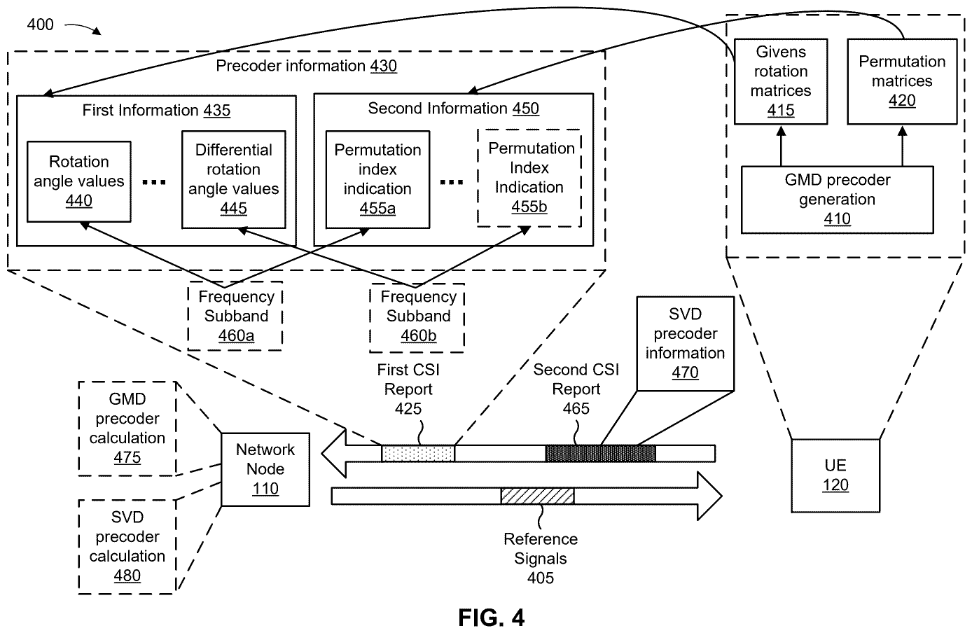

FIG. 4 is a diagram illustrating an example 400 associated with efficient signaling of a GMD precoder. In some instances, example 400 may implement or be implemented by one or more aspects of FIGS. 1 through 3. For instance, FIG. 4 may illustrate wireless communications between the network node 110 and the UE 120. Additionally, example 400 may be associated with the UE 120 generating a GMD precoder and decomposing the GMD precoder to reduce a signal load associated with transmitting a CSI report that indicates the GMD precoder.

As shown in FIG. 4, the network node 110 may transmit, and the UE 120 may receive, one or more reference signals. In some examples, the one or more reference signals may include one or more CSI-RSs, among other examples. The network node 110 may transmit the one or more reference signals for measurement of an associated transmission channel (e.g., transmission channel 330) by the UE 120. For example, the UE 120 may measure the set of reference signals in order to report channel variables that the network node 110 may use to improve communications with the UE 120. In some examples, the network node 110 may transmit, and the UE 120 may receive, a configuration associated with the one or more reference signals, prior to reception of the one or more reference signals. For example, such a configuration may include a CSI-ResourceConfig information element (IE) or a CSI-ReportConfig IE, as defined in 3GPP specifications.

In accordance with measuring the one or more reference signals 405, the UE 120 may perform a GMD precoder generation 410 (e.g., to generate the GMD precoder 325). For example, as part of the GMD precoder generation 410, the UE 120 may estimate a frequency response and spatial properties of the transmission channel associated with receiving the one or more reference signals. In other words, the UE 120 may perform channel estimation on the one or more reference signals 405 to construct a channel matrix that represents a propagation environment associated with the transmission channel. Using the estimated channel matrix, the UE 120 may calculate the generalized SVD to derive singular vectors and singular values of the transmission channel (e.g., associated with Equation 2 and Equation 3, with reference to FIG. 3). In accordance with the singular vectors and singular values, the UE 120 may generate the GMD precoder, which ensures that the one or more reference signals undergo uniform scaling across the sub-channels of the transmission. Accordingly, the GMD precoder generation 410 may generate a GMD precoder that reduces inter-stream interference and increases a capacity of the transmission channel based on equalizing the effective channel gain for a set of spatial streams.

As described elsewhere herein, the transmission channel may include one or more frequency subbands 460. A frequency subband of the transmission channel may be a smaller segment of the bandwidth of the transmission channel to facilitate more granular resource allocation and management. For example, as shown in FIG. 4, the transmission channel may include a frequency subband 460a (e.g., a first frequency subband) and a frequency subband 460b (e.g., a second frequency subband). In some examples, the transmission channel may be divided into any number of frequency subbands 460. Additionally, the one or more frequency subbands 460 of the transmission channel may be respectively associated with one or more GMD precoders. For example, as part of the GMD precoder generation 410, the UE 120 may generate a first GMD precoder associated with the frequency subband 460a and a second GMD precoder associated with the frequency subband 460b.

In some examples, signaling multiple quantized GMD precoders for multiple frequency subbands 460 may increase signaling overhead. To reduce a number of bits associated with indicating a GMD precoder, the UE 120 may decompose the GMD precoder (P) into one or more Givens rotation matrices 415 (U) and one or more permutation matrices 420 (Sⱼ), as described in Equation 9:

$$P = {\prod }_{j = N - 2}^{0} {U}_{j} {S}_{j} \qquad ( 9 )$$

where N is a number of spatial layers associated with the transmission channel. For example, the GMD precoder (P) may represent the product of a sequence of a cumulative product of pairs Uⱼ and Sⱼ over the range of j values, starting from j=N−2 down to j=0. In other words, the UE 120 may decompose the GMD precoder (P) into N−1 Givens rotation matrices 415 and N−1 permutation matrices 420. In some examples, the term “j” with respect to Equation 9 may be referred to herein as a “permutation level”.

Accordingly, the UE 120 may transmit a first CSI report 425 that includes precoder information 430 indicative of one or more GMD precoders. For example, as shown in FIG. 4, the precoder information may include first information 435 associated with or indicative of the one or more Givens rotation matrices 415 and second information 450 associated with or indicative of the one or more permutation matrices 420. In some examples, the UE 120 may encode the first information 435 separately from the second information 450 (e.g., Uⱼ and Sⱼ may be encoded separately). The separation of the first information 435 and the second information 450 may be in accordance with one or more of time division (e.g., transmitted in different time segments of the first CSI report 425), frequency division (e.g., transmitted over different frequency subbands 460), spatial division (e.g., transmitted over different spatial streams), code division (e.g., transmitted using different coding schemes), or layer division (e.g., encoded using different logical layers or processing blocks).

In some examples, a general form of a Givens rotation matrix (Uₗ) may be described in accordance with Equation 10:

$${U}_{l} ( i , j , θ ) = [ \begin{matrix}1 & 0 & 0 & 0 & 0 & 0 \\ 0 & ⋱ & 0 & 0 & 0 & 0 \\ 0 & 0 & cos ( {θ}_{l} ) & - sin ( {θ}_{l} ) & 0 & 0 \\ 0 & 0 & sin ( {θ}_{l} ) & cos ( {θ}_{l} ) & 0 & 0 \\ 0 & 0 & 0 & 0 & ⋱ & 0 \\ 0 & 0 & 0 & 0 & 0 & 1\end{matrix} ] \qquad ( 10 )$$

where Uₗ is an N×N matrix, and where N is equal to the number of spatial layers associated with the transmission channel. Additionally, as shown in Equation 10, Uₗ is an identity matrix, except for a block at rows and columns i and j, which include rotation components. For example, the rotation components rotate the i-th and j-th coordinates by an angle of θₗ. Accordingly, if N=3, then there may be two Givens rotation matrices 415 (e.g., U₀ and U₁) that are associated with a GMD precoder, as described in Equation 11:

$${U}_{0} = [ \begin{matrix}cos ( {θ}_{0} ) & - sin ( {θ}_{0} ) & 0 \\ sin ( {θ}_{0} ) & cos ( {θ}_{0} ) & 0 \\ 0 & 0 & 1\end{matrix} ] , {U}_{1} = [ \begin{matrix}1 & 0 & 0 \\ 0 & cos ( {θ}_{1} ) & - sin ( {θ}_{1} ) \\ 0 & sin ( {θ}_{1} ) & cos ( {θ}_{1} )\end{matrix} ] \qquad ( 11 )$$

Alternatively, if N=3, then there may be one Givens rotation matrix (e.g., U₀) that is associated with a GMD precoder, as described in Equation 12:

$${U}_{0} = [ \begin{matrix}cos ( {θ}_{0} ) & - sin ( {θ}_{0} ) \\ sin ( {θ}_{0} ) & cos ( {θ}_{0} )\end{matrix} ] \qquad ( 12 )$$

As described herein, a GMD precoder may be associated with one or more Givens rotation matrices 415 that are respectively associated with one or more rotation angle values 440. For example, in accordance with Equation 11, the first GMD precoder associated with the frequency subband 460a may be associated with a first Givens rotation matrix (U₀) that includes a first rotation angle value (θ₀) and a second Givens rotation matrix (Uₗ) that includes a second rotation angle value (θ₁). In some examples, the first information 435 may include one or more rotation values 440 respectively associated with the one or more Givens rotation matrices 415. For example, if the number of spatial layers is N=3, then the one or more rotation angle values 445 may include θ₀, and θ₁ to describe the first GMD precoder associated with the frequency subband 460a.

Additionally, different frequency subbands 460 may be associated with differential rotation angle values 445. For instance, the frequency subband 460a may be a k-th subband and the frequency subband 460b may be a k−1-th subband (e.g., an adjacent subband). In some examples, θₗ(k) may be correlated or associated with θₗ(k−1). Accordingly, the UE 120 may generate differential rotation angle values 445 for the frequency subband 460b, where a differential rotation angle value (401) may be described with reference to Equation 13:

$$Δ {θ}_{l} = {θ}_{l} ( k ) - {θ}_{l} ( k - 1 ) \qquad ( 13 )$$

For example, if the rotation angle values 440 for the subband 460a are θ₀ (k) and θ₁(k), then the differential rotation angle values 445 associated with or indicative of the frequency subband 460b may be Δθ₀, and Δθ₁, where Δθ₀=0. (k)−θ₀ (k−1) and Δθ₁=θ₁(k)−θ₁(k−1). In some examples, the UE 120 may be able to quantize 400 and 401 using fewer bits than θ₀ (k−1) and θ₁(k−1). Therefore, the differential rotation angle values 445 may indicate the Givens rotation matrices 415 corresponding to the frequency subband 460b while reducing the signaling overhead of the first CSI report 425.

In accordance with Equation 9, a permutation matrix(S) multiplies a corresponding Givens rotation matrix (Uⱼ) from the right (e.g., UⱼSⱼ). Accordingly, the Givens rotation matrix (Uⱼ) may be an example of a target matrix, where the permutation matrix (Sⱼ) rearranges the columns of the target matrix based on a permutation encoded in Sⱼ. For instance, an example of multiplying U, from Equation 12 by an example permutation matrix (S₀) is described in accordance with Equation 14:

$${U}_{0} {S}_{0} = [ \begin{matrix}cos ( {θ}_{0} ) & - sin ( {θ}_{0} ) & 0 \\ sin ( {θ}_{0} ) & cos ( {θ}_{0} ) & 0 \\ 0 & 0 & 1\end{matrix} ] [ \begin{matrix}0 & 1 & 0 \\ 1 & 0 & 0 \\ 0 & 0 & 1\end{matrix} ] = [ \begin{matrix}- sin ( {θ}_{0} ) & cos ( {θ}_{0} ) & 0 \\ cos ( {θ}_{0} ) & sin ( {θ}_{0} ) & 0 \\ 0 & 0 & 1\end{matrix} ] \qquad ( 14 )$$

With reference to Equation 14, the first column of S₀ includes a “1” in the second row, which indicates to move the first column of U₀ to the second column of U₀. The second column of S₀ includes a “1” in the first row, which indicates to move the second column of U₀ to the first column of U₀. The third column of S₀ includes a “1” in the third row, which indicates to move the third column of U₀ to the third column of U₀ (e.g., the third column of U, remains the same). In other words, the S₀ of Equation 14 swaps the first and second columns of U₀.

As described herein, a permutation matrix(S) swaps different columns of the corresponding Givens rotation matrix (Uⱼ). Therefore, for a given number of spatial layers (e.g., N) and a given permutation level (e.g., j), there may be a finite number of possible permutation matrices(S) that can be applied to a Givens rotation matrix (U). For example, in accordance with Equation 9, S may swap columns of Uⱼ from column j to N−1, where j to N−1 may be a range of columns. Accordingly, the number of possible permutation matrices (Sⱼ) for N spatial layers may be equal to (N−j)! permutations.

In accordance with the techniques described herein, the first CSI report 425 may indicate the one or more permutation matrices 420 associated with the one or more GMD precoders in accordance with a factorial number system. In some examples, the UE 120 and the network node 110 may be associated with one or more implementations of the factorial number system.

In a first implementation, the factorial number system may be associated with indicating the number of possible permutation matrices for N spatial layers and a permutation level of “j”. For example, each possible permutation of Sⱼ may be associated with a permutation index from a set of permutation indexes. Therefore, because there are (N−j)! permutations possible for a permutation matrix Sⱼ, a number of bits (N_{bits}) used to encode the permutation matrix Sⱼ may be defined in accordance with Equation 15:

$${N}_{bits} = ⌈ {log}_{2} ( ( N - j ) ! ) ⌉ \qquad ( 15 )$$

where the value for N_{bits} is rounded up to the nearest integer value. In a first example of the first implementation, where N=4 (e.g., four spatial layers), the UE 120 may generate a set of permutation matrices 420 that include S₀, S₁, and S₂, which are associated with the first GMD precoder for the frequency subband 460a. In such a first example (where N=4) the permutation matrix S₀ may be associated with a first set of permutation indexes that includes (4-0)! indexes (24 indexes), the permutation matrix S₁ may be associated with a second set of permutation indexes that includes (4-1)! indexes (6 indexes), and the permutation matrix S₂ may be associated with a third set of permutation indexes that includes (4-2)! indexes (2 indexes). Additionally, the first, second, and third set of permutation indexes may be defined in a wireless communications standard, such as 3GPP. Therefore, in accordance with Equation 15, the second information 450 may include a permutation index indication 455a that includes five bits to indicate S₀ from the first set of permutation indexes, includes three bits to indicate S₁ from the second set of permutation indexes, and includes one bit for S₂ from the third set of permutation indexes. Therefore if N=4, according to the first implementation of the factorial number system, the permutation index indication 455a may include nine bits to indicate the permutation matrices 420 associated with the GMD precoder for the frequency subband 460a. Accordingly, by pointing to multiple defined sets of permutation indexes, the first implementation of the factorial number system may reduce the overhead associated with indicating GMD precoders. Additionally, the first implementation of the factorial number system is associated with sets of permutation indexes that include (N−j)! permutations possible for a given permutation matrix Sⱼ, which may increase the flexibility at the UE 120 in the selection of each permutation matrix for a given number of spatial layers “N” and a given permutation level “j”.

In a second implementation, the factorial number system may be associated with reducing the number of indexes associated with a given permutation matrix Sⱼ. For example, in accordance with Equation 9, a permutation matrix Sⱼ is used to swap the j-th and (j+1)-th columns of the associated Givens rotation matrix Uⱼ(e.g., a first column pair) with two other neighboring columns of the associated Givens rotation matrix Uⱼ(e.g., a second column pair), where the second column pair is in a range of columns between the j-th and (N−1)-th columns of the associated Givens rotation matrix Uⱼ. In other words, because the permutation matrix Sⱼ is used to swap a first column pair and a second column pair of the Givens rotation matrix Uⱼ (within a defined range of columns), a GMD precoder may be constructed using only a subset of the (N−j)! possible permutations for a permutation matrix Sⱼ. Therefore, the second implementation of the factorial number system may be associated with a reduced number of permutations for a given permutation matrix Sⱼ, which may be equal to

$$( \frac{( N - j ) !}{( N - j - 2 ) !} )$$

permutations. Accordingly, because there are

$$( \frac{( N - j ) !}{( N - j - 2 ) !} )$$

permutations used for a given permutation matrix Sⱼ, a number of bits (N_{bits}) used to encode the given permutation matrix Sⱼ may be defined in accordance with Equation 16:

$${N}_{bits} = ⌈ {log}_{2} ( \frac{( N - j ) !}{( N - j - 2 ) !} ) ⌉ \qquad ( 16 )$$

where the value for N_{bits} is rounded up to the nearest integer value. In a first example of the second implementation, where N=4 (e.g., four spatial layers), the UE 120 may generate a set of permutation matrices 420 that include S₀, S₁, and S₂, which are associated with the first GMD precoder for the frequency subband 460a. In such a first example (where N=4), the permutation matrix S₀ may be associated with a first set of permutation indexes that includes

$$( \frac{( 4 - 0 ) !}{( 4 - 0 - 2 ) !} )$$

indexes (12 indexes), the permutation matrix S₁ may be associated with a second set of permutation indexes that includes

$$( \frac{( 4 - 1 ) !}{( 4 - 1 - 2 ) !} )$$

indexes (6 indexes), and the permutation matrix S₂ may be associated with a third set of permutation indexes that includes

$$( \frac{( 4 - 2 ) !}{( 4 - 2 - 2 ) !} )$$

indexes (2 indexes). Additionally, the first, second, and third set of permutation indexes may be defined in a wireless communications standard, such as 3GPP. Therefore, in accordance with Equation 16, the permutation index indication 455a may include four bits to indicate S₀ from the first set of permutation indexes, include three bits to indicate S₁ from the second set of permutation indexes, and include one bit for S₂ from the third set of permutation indexes. Therefore, if N=4, and according to the second implementation of the factorial number system, the permutation index indication 455a may include eight bits to indicate the permutation matrices 420 associated with the GMD precoder for the frequency subband 460a. Accordingly, by pointing to multiple defined sets of permutation indexes, the second implementation of the factorial number system may reduce the overhead associated with indicating GMD precoders. Additionally, the second implementation of the factorial number system is associated with sets of permutation indexes that include

$$( \frac{( N - j ) !}{( N - j - 2 ) !} )$$

possible permutations for a given permutation matrix Sⱼ, which may further decrease the number of bits included in the permutation index indication 455a (relative to the first implementation of the factorial number system).

In a third implementation, the factorial number system may be associated with reducing the number of bits included in the second information 450 by setting the permutation matrix S₀ to a single fixed possible permutation. For instance, an example of pre-multiplying a target matrix (Θⱼ) with a given permutation matrix Sⱼ and post-multiplying the target matrix (Θⱼ) with the transpose of the given permutation matrix

$${S}_{j} ( {S}_{j}^{T} )$$

may be described with reference to Equation 17:

$${S}_{j} {θ}_{j} {S}_{j}^{T} = [ \begin{matrix}σ & x & x & 0 & 0 & 0 \\ 0 & ⋱ & x & ⋮ & ⋮ & ⋮ \\ ⋮ & 0 & {η}_{j} & 0 & ⋮ & ⋮ \\ ⋮ & ⋱ & 0 & {σ}_{j + 1} & 0 & ⋮ \\ ⋮ & ⋱ & ⋱ & 0 & ⋱ & 0 \\ 0 & ⋯ & ⋯ & ⋯ & 0 & {σ}_{N - 1}\end{matrix} ] = [ \begin{matrix}σ & x & x & 0 & 0 & 0 \\ 0 & ⋱ & x & ⋮ & ⋮ & ⋮ \\ ⋮ & 0 & {σ}_{m} & 0 & ⋮ & ⋮ \\ ⋮ & ⋱ & 0 & {σ}_{k} & 0 & ⋮ \\ ⋮ & ⋱ & ⋱ & 0 & ⋱ & 0 \\ 0 & ⋯ & ⋯ & ⋯ & 0 & {σ}_{N - 1}\end{matrix} ] \qquad ( 17 )$$

In other words, in GMD decomposition, the purpose of the permutation Sⱼ may be to swap the j-th and the (j+1)-th diagonal elements

$$( {η}_{j} , {σ}_{j + 1} ) of {Θ}_{j} = {V}_{j - 1} {S}_{j - 1} {Θ}_{j - 1} {S}_{j - 1}^{T} {U}_{j - 1}^{H}$$

with the later diagonal elements, such that σₘ>σ>σₖ where σ is the geometric mean of the diagonal elements of Θ=Θ₀. Therefore, if it is assumed that the SVD orders singular values from largest to smallest, then the permutation matrix

$${S}_{j}^{T}$$

may be made in accordance with Equation 18:

$${S}_{0}^{T} = [ \begin{matrix}1 & 0 & * & 0 \\ 0 & 0 & * & 1 \\ ⋮ & ⋮ & * & ⋮ \\ 0 & 1 & * & 0\end{matrix} ] \qquad ( 18 )$$

$${S}_{0}^{T}$$

where the column including values of “*” may describe zero or more additional columns or that may not be associated with swapping the first, second, or last columns of a target matrix. Further, Equation 18 may keep the first column of a target matrix in the first column (e.g., keep the first largest σ₀) and may swap the second column and the last column (N−1) of the target matrix (e.g., swap σ₁ with the smallest σ_{N-1}).

Therefore, the third implementation of the factorial number system may be associated with setting the value of

$${S}_{0}^{T}$$

(e.g., a lowest level permutation matrix of the one or more permutation matrices) in accordance with Equation 18. Additionally, the third implementation of the factorial number system may be associated with a reduced number of permutations for a given permutation matrix Sⱼ equal to

$$( \frac{( N - j ) !}{( N - j - 2 ) !} )$$

permutations. Accordingly, because there are

$$( \frac{( N - j ) !}{( N - j - 2 ) !} )$$

permutations used for a given permutation matrix Sⱼ, a number of bits (N_{bits}) used to encode the given permutation matrix Sⱼ may be defined in accordance with Equation 16. For instance, in a first example of the third implementation, where N=4 (e.g., four spatial layers), the UE 120 may generate a set of permutation matrices 420 that include S₀, S₁, and S₂, which are associated with the GMD precoder for the frequency subband 460a. In such a first example (where N=4), the permutation matrix S₀ may be associated with a single index indicating a single fixed value of S₀ in accordance with Equation 18, the permutation matrix S₁ may be associated with a second set of permutation indexes that includes

$$( \frac{( 4 - 1 ) !}{( N - 1 - 2 ) !} )$$

indexes (6 indexes), and the permutation matrix S₂ may be associated with a third set of permutation indexes that includes

$$( \frac{( 4 - 1 ) !}{( 4 - 2 - 2 ) !} )$$

indexes (2 indexes). Additionally, the second and third set of permutation indexes may be defined in a wireless communications standard, such as 3GPP. Therefore, in accordance with Equations 16 and 18, the second information 450 may include a permutation index indication 455a that includes zero bits to indicate S₀ based on setting

$${S}_{0}^{T}$$

to the fixed permutation matrix, includes three bits to indicate S₁ for the second set of permutation indexes, and includes one bit for S₂ for the third set of permutation indexes. Therefore if N=4, according to the third implementation of the factorial number system, the permutation index indication 455a may include four bits to indicate the permutation matrices 420 associated with the first GMD precoder for the frequency subband 460a. Accordingly, by pointing to multiple defined sets of permutation indexes, the third implementation of the factorial number system may reduce the overhead associated with indicating GMD precoders. Additionally, the third implementation of the factorial number system is associated with sets of permutation indexes that include

$$( \frac{( N - j ) !}{( N - j - 2 ) !} )$$

permutations possible for a given permutation matrix Sⱼ, which may further decrease the number of bits included in the permutation index indication 455a (relative to the first implementation of the factorial number system). Further, the third implementation of the factorial number system is associated with including no bits for S₀, which may further decrease the number of bits included in the permutation index indication 455a relative to the second implementation of the factorial number system.

In any of the first, second, or third implementation of the factorial number system, if N=2 (e.g., two spatial layers), then the GMD precoder for the frequency subband 460a may be associated with a single permutation matrix that is equal to the identity matrix (I). Therefore, in cases where N=2, the first CSI report 425 may not include the second information 450, which may reduce the payload size and signaling overhead of the first CSI report 425.

Additionally, different frequency subbands 460 may be associated with the same or different permutation matrices 420. For example, as shown in FIG. 4, the second information 450 may optionally include permutation index indication 455b that indicates the permutation matrices 420 associated with the GMD precoder for the frequency subband 460b. For instance, the frequency subband 460a may be a k-th subband and the frequency subband 460b is a (k−1)-th subband (e.g., an adjacent subband). In some examples, Sⱼ(k) may be correlated or associated with Sⱼ(k−1). For instance, there may be a probability above a probability threshold that Sⱼ(k)=Sⱼ(k−1). In other words, if N=4, then S₀, S₁, and S₂ associated with the first GMD precoder for the frequency subband 460a may have a high probability of being respectively equal to S₀, S₁, and S₂ associated with the second GMD precoder for the frequency subband 460b.

Based on a high probability that Sⱼ(k)=Sⱼ(k−1), the UE 120 may differentially encode Sⱼ across contiguous frequency subbands 460. For example, if N=4, then the set of bits that indicate S₁(k) in permutation index indication 455a may include one code point (e.g., an additional bit) that indicates whether S₁(k) is the same as Sⱼ(k−1). If the one codepoint indicates that a given Sⱼ(k) is different than Sⱼ(k−1), then the permutation index indication 455b may include bits to indicate S (k−1). If, however, the one codepoint indicates that a given Sⱼ(k) is the same as Sⱼ(k−1), then the permutation index indication 455b may not include bits to indicate Sⱼ(k−1), which may reduce the payload size of the first CSI report 425. Therefore, differential encoding of Sⱼ(k) across contiguous frequency subbands 460 may reduce the signaling overhead of the first CSI report 425.

In accordance with receiving the first CSI report 425, the network node 110 may perform a GMD precoder calculation 475. For example, the network node 110 may calculate one or more GMD precoders respectively associated with the one or more frequency subbands 460 of the transmission channel. With reference to example 400, the network node 110 may use the rotation angle values 440 encoded in the first information 435 to generate the set of Givens rotation matrices 415 associated with the first GMD precoder for the frequency subband 460a (e.g., if N=4, the network node 110 generates U₀, U₁, and U₂ using the rotation angle values 440). Additionally, the network node 110 may use the permutation index indication 455a encoded in the second information 450 to generate the set of permutation matrices 420 associated with the first GMD precoder for the frequency subband 460a (e.g., if N=4, the network node 110 generates S₀, S₁, and S₂ using the permutation index indication 455a). Therefore, in accordance with Equation 9, the network node 110 may calculate the GMD precoder for the frequency subband 460a after generating the set of Givens rotation matrices 415 and the set of permutation matrices 420. As part of the GMD precoder calculation 475, the network node 110 may similarly calculate the second GMD precoder for the frequency subband 460b (e.g., using the differential rotation angle values 445 and the permutation index indication 455b). Therefore, the network node 110 may determine one or more GMD precoders to respectively apply the one or more frequency subbands 460 to the transmission channel using the precoder information 430 included in the first CSI report 425.

In some examples, as shown in FIG. 4, the UE 120 may transmit, and the network node 110 may receive, a second CSI report 465 that may indicate the SVD precoder information 470. In some examples, the SVD precoder information 470 may be associated with one or more parameters of Equation 3. For example, the SVD precoder information 470 may include a quantized DFT basis (e.g., represented by B=[b₀, . . . , b_{L-1}]) and a set of quantized elements of the unitary matrix V_{w}. In some examples, the SVD precoder information 470 may be the same for each frequency subband (e.g., the SVD precoder is the same for the frequency subband 460a and the frequency subband 460b). In some other examples, the SVD precoder information 470 may be different for each frequency subband. For example, the SVD precoder information 470 may include a first subset of information that indicates a first quantized DFT basis and a first set of quantized elements of the unitary matrix V_{w} associated with the frequency subband 460a, and include a second subset of information that indicates a second quantized DFT basis and a second set of quantized elements of the unitary matrix V_{w} associated with the frequency subband 460b. In some such examples, the second subset of information may be differential and relative to the first subset of information. That is, the second quantized DFT basis may include differential values relative to the first quantized DFT basis and the second set of quantized elements of the unitary matrix V_{w} may include differential values relative to the first set of quantized elements of the unitary matrix V_{w}. Such differential indications included in the SVD precoder information 470 may decrease the signaling overhead associated with the second CSI report 465.

In accordance with receiving the second CSI report 465, the network node 110 may perform an SVD precoder calculation 480. For example, the network node 110 may calculate one or more SVD precoders respectively associated with the one or more frequency subbands 460 of the transmission channel. With reference to example 400, the network node 110 may use the first quantized DFT basis and a first set of quantized elements of the unitary matrix V_{w} to calculate the SVD precoder associated with the frequency subband 460a. Additionally, the network node 110 may use the second quantized DFT basis and a second set of quantized elements of the unitary matrix V_{w} to calculate the SVD precoder associated with the frequency subband 460b. Therefore, the network node 110 may determine one or more SVD precoders to respectively apply to the one or more frequency subbands 460 of the transmission channel using the SVD precoder information 470 included in the second CSI report 465.

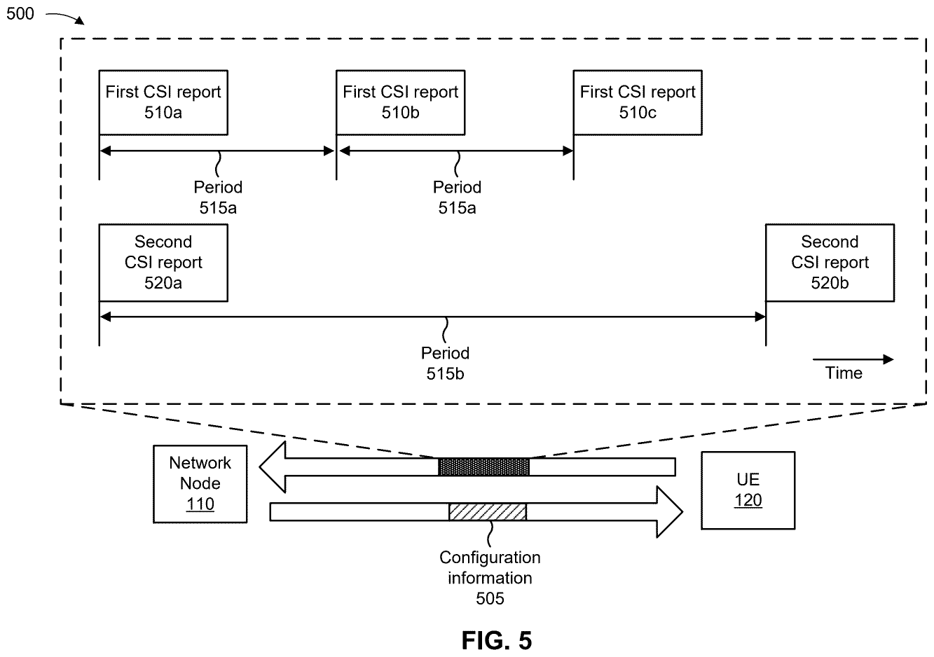

In some examples, the UE 120 may transmit the first CSI report 425 and the second CSI report 465 using different periodicities, as described elsewhere herein (e.g., including with reference to FIG. 5).

As indicated above, FIG. 4 is provided as an example. Other examples may differ from what is described with regard to FIG. 4.

FIG. 5 is a diagram illustrating an example 500 associated with separate signaling for different types of precoders. In some instances, example 500 may implement or be implemented by one or more aspects of FIGS. 1 through 4. For instance, FIG. 5 may illustrate wireless communications between the network node 110 and the UE 120. Additionally, example 500 may be associated with the UE 120 periodically transmitting a first CSI report 510, which may be an example of the CSI report 425, and periodically transmitting a second CSI report 520, which may be an example of the second CSI report 465.

As shown in FIG. 5, the network node 110 may transmit, and the UE 120 may receive, configuration information 505. In some examples, the configuration information 505 may be indicated via one or more of system information (e.g., including a master information block (MIB) or a SIB), RRC signaling, MAC signaling (e.g., including one or more MAC-CEs), or DCI signaling. The configuration information 505 may configure periodic transmission of the first CSI report 510 and periodic transmission of the second CSI report 520. For example, the configuration information 505 may indicate for transmissions of the first CSI report 510 to include the precoder information associated with calculating one or more GMD precoders for the network node 110 to respectively apply to one or more subbands of a transmission channel (e.g., the precoder information 430). In some examples, the configuration information 505 may optionally indicate for the transmissions of the first CSI report 510 to additionally indicate a power loading matrix (e.g., the power loading matrix 320). Additionally, the configuration information 505 may indicate for the transmissions of the second CSI report 520 to include SVD precoder information associated with calculating one or more SVD precoders for the network node 110 to respectively apply to one or more frequency subbands of the transmission channel (e.g., the SVD precoder information 470).

In some examples, the configuration information 505 may indicate respective periods 515 for transmission of the first CSI report 510 and the second CSI report 520. For example, the configuration information 505 may indicate for the UE 120 to transmit repetitions of the first CSI report 510 using a period 515a and indicate for the UE 120 to transmit repetitions of the second CSI report 520 using a period 515b. In some examples, the period 515b may be greater than the period 515a such that the UE 120 may be configured to update the one or more GMD precoders (and optionally the power loading matrix) more frequently than the one or more SVD precoders. As described elsewhere herein, the UE 120 may update the one or more GMD precoders (and optionally the power loading matrix) more frequently based on temporal variations in channel gains in Σₕ(t) changing faster than the directionality or geometry of the transmission channel. Therefore, based on period 515b being greater than 515a, signaling overhead associated with updating SVD precoders may be reduced while maintaining the accuracy of the SVD precoders.

In accordance with the configuration information 505, the UE 120 may transmit repetitions of the first CSI report 510 using the period 515a (e.g., a first CSI report 510a, 510b, and 510c) and transmit repetitions of the second CSI report 520 using the period 515b (e.g., a second CSI report 520a and 520b).

In some examples, the network node 110 may transmit, and the UE 120 may receive, dynamic control signaling (e.g., MAC-CE signaling or DCI signaling) that triggers an aperiodic transmission of the first CSI report 510 to supplement the SVD precoder information obtained in the periodic transmissions of the second CSI report 520a. Such aperiodic transmissions of the first CSI report 510 may be in addition to or alternative to the periodic transmissions configured via the configuration information 505. In some examples, the dynamic triggering of the first CSI report 510 may enable the network node 110 to adapt how often the UE updates the one or more GMD precoders (and optionally the power loading matrix) in accordance with temporal variation of the transmission channel. For example, in cases where temporal variation of the transmission is above a variation threshold (e.g., channel gains in Σₕ(t) are changing quickly), the network node 110 may trigger one or more additional transmissions of the first CSI report 510 to maintain up-to-date precoding information. In cases where temporal variation of the transmission is below the variation threshold (e.g., channel gains in Σₕ(t) are changing slowly), the network node 110 may reduce the number of transmissions of the first CSI report 510 to reduce signaling overhead.

As indicated above, FIG. 5 is provided as an example. Other examples may differ from what is described with regard to FIG. 5.

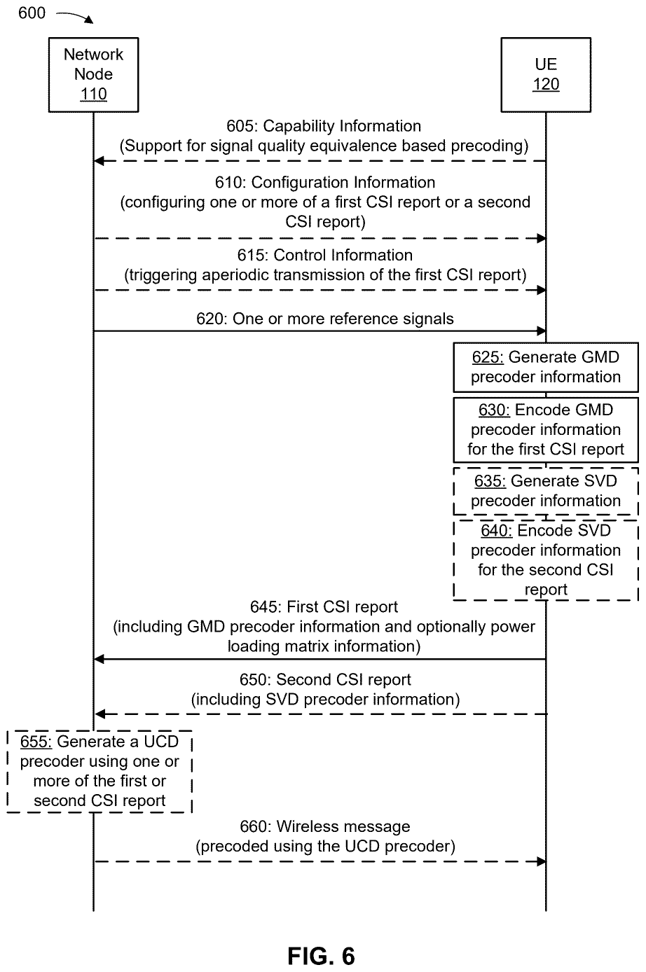

FIG. 6 is a diagram illustrating an example 600 associated with encoding of a precoder for spatial layer signal quality equivalence. Example 600 may implement or be implemented by one or more aspects of FIGS. 1 through 5. For instance, example 600 includes wireless communications between the network node 110 and the UE 120. Alternative examples of the following may be implemented, where some operations are performed in a different order than described, or not described at all. In some cases, one or more operations may include additional features not mentioned below, or further operations may be added. In addition, while example 600 shows operations between the UE 120 and the network node 110, the communication may occur between any number of network devices of various types described herein.

In a first operation 605, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE 120 assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), or a physical sidelink shared channel (PSSCH)), among other examples. The capability information may indicate one or more parameters associated with respective capabilities of the UE 120. The one or more parameters may be indicated via respective IEs included in a capability report.

The capability information may indicate whether the UE 120 supports a feature or one or more parameters related to the feature. For example, the capability information may indicate a capability or parameter for supporting a signal quality equivalence based precoding for wireless messages. In other words, the capability information may indicate that the UE 120 is capable of decoding wireless messages that are precoded in accordance with signal quality equivalence across a set of spatial layers of a transmission channel (e.g., a GMD precoder or a UCD precoder). In some examples, the capability information may indicate a capability or parameter that indicates that the UE 120 includes a reception component that supports one or more of GMD or UCD (such as a reception component 902). One or more operations described herein may be based on the capability information. For example, the UE 120 may perform one or more operations of example 600 in accordance with the capability information or may receive one or more of configuration information or control information that is in accordance with the capability information.

The network node 110 may determine configuration information for the UE 120 based on the capability information. For example, the network node 110 may determine that the UE 120 is to be enabled to decode or de-map wireless messages that are precoded using GMD or UCD precoding techniques based on the capability information.

In a second operation 610, the network node 110 may optionally transmit, and the UE 120 may receive, the configuration information. In some examples, the configuration information of the second operation 610 may be an example of the configuration information 505. In some aspects, the UE 120 may receive the configuration information via one or more of system information signaling (e.g., a MIB or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may indicate that signal quality equivalence based precoding is enabled. For example, the configuration information may indicate that a GMD or UCD precoder is applied for one or more subsequent wireless transmissions.

In some examples, the configuration information may configure the UE 120 to transmit repetitions of a first CSI report (e.g., the first CSI report 510) in accordance with a first period (e.g., the period 515a). Additionally, or alternatively, the configuration information may configure the UE 120 to transmit repetitions of a second CSI report (e.g., the second CSI report 520) in accordance with a second period (e.g., associated with the period 515b). In some examples, the second period may be greater than the first period (e.g., configures the UE 120 to transmit repetitions of the first CSI report more frequently than the second CSI report). In some examples, the first CSI report and the second CSI report may be examples of type-2 CSI reports. For example, a type-2 report may provide channel information for one or more frequency subbands (e.g., smaller frequency blocks within the channel bandwidth) rather than the entire bandwidth.

In some examples, the configuration information may schedule one or more reference signals, prior to reception of the one or more reference signals. For example, the configuration information may include a CSI-ResourceConfig IE or a CSI-ReportConfig IE, as defined in 3GPP specifications.

In a third operation 615, the network node 110 may optionally transmit, and the UE 120 may receive, control information (e.g., via MAC-CE or DCI) that triggers one or more aperiodic transmissions of the first CSI report. In some examples, the control information may be in addition to the configuration of the first CSI report via the configuration information. In other words, the control information may trigger the UE 120 to transmit one or more aperiodic transmissions of the first CSI report in addition to the periodic transmissions of the first CSI report configured in the configuration information. In some examples, the control information may be alternative to the configuration of the first CSI report via the configuration information. In other words, the control information may schedule aperiodic transmissions of the first CSI report that supplement periodic transmissions of the second CSI report configured via the configuration information.

In a fourth operation 620, the network node 110 may transmit, and the UE 120 may receive, one or more reference signals (e.g., the one or more reference signals 405) associated with measurement of a signal quality associated with a transmission channel (e.g., the transmission channel 330). In some examples, the one or more reference signals may be CSI-RSs. In some other examples, the one or more reference signals may be one or more of SSBs, DMRSs, or PTRSs. In some examples, the configuration information may configure periodic transmission of the one or more reference signals. In some examples, the control information may configure aperiodic transmission of the one or more reference signals.

In a fifth operation 625, the UE 120 may generate GMD precoder information. In some examples, the fifth operation 625 may implement or be implemented by one or more aspects of the GMD precoder generation 410. For example, the UE 120 may measure the one or more reference signals and perform GMD decomposition (as described elsewhere herein) to generate first information (e.g., the first information 435) associated with one or more Givens rotation matrices (e.g., the Givens rotation matrices 415) and second information (e.g., the second information 450) associated with one or more permutation matrices (e.g., the permutation matrices 420). Accordingly, the network node 110 may use the first information and the second information to calculate one or more GMD precoders respectively associated with one or more frequency subbands of the transmission channel (e.g., in accordance with Equation 9).

In some examples, the first information (associated with the one or more Givens rotation matrices) may include one or more rotation angle values respectively associated with the one or more Givens rotation matrices. In some examples, the one or more rotation angles values may include a first subset of rotation angle values (e.g., the rotation angle values 440) associated with a first frequency subband (e.g., the frequency subband 460a). In some examples, the one or more rotation angle values may include a second subset of rotation angle values associated with a second frequency subband (e.g., the frequency subband 460a). For example, the second subset of rotation angle values may be a subset of differential rotation angle values (e.g., differential rotation angle values 445) that may be relative to the first subset of rotation angle values.

In some examples, a permutation matrix of the one or more permutation matrices may be associated with a set of permutation indexes that is in accordance with a factorial number system, where the second information may include a set of bits that indicates an index from the set of permutation indexes associated with the permutation matrix. In some examples, a number of indexes included in the set of permutation indexes may be in accordance with the factorial number system.

As described elsewhere herein, in accordance with a first implementation, the factorial number system may be associated with the set of permutation indexes that indicates a set of possible column-swapping patterns for a range of columns of a target matrix. Additionally, the range of columns spans from a column of the target matrix associated with a permutation level of the permutation matrix to a last column of the target matrix. In accordance with the first implementation of the factorial number system, the set of permutation indexes may include (N−j)! indexes.

As described elsewhere herein, in accordance with a second implementation, the factorial number system may be associated with the set of permutation indexes that indicates a set of possible column-swapping patterns for a range of columns of a target matrix to swap a first pair of columns in the target matrix with a second pair of columns in the target matrix. For example, the first pair of columns may include a first column associated with a permutation level (e.g., the j-th column) of the permutation matrix and a second column that is directly after the first column (e.g., the (j+1)-th column). Additionally the range of columns may span from a column of the target matrix associated with the permutation level of the permutation matrix to a last column of the target matrix (e.g., the range of columns spans from the j-th column to the (N−1)-th column). In accordance with the second implementation of the factorial number system, the set of permutation indexes may include

$$( \frac{( N - j ) !}{( N - j - 2 ) !} )$$

indexes.

As described elsewhere herein, in accordance with a third implementation, the factorial number system may associated with a lowest level permutation matrix of the one or more permutation matrices (e.g., S₀) that has a fixed column order. In other words, the lowest level permutation matrix may be fixed in accordance with Equation 18.

In some examples, the set of permutation indexes associated with the permutation matrix may be defined in a wireless communication standard, such as 3GPP. For instance, the wireless communication standard may define multiple sets of permutation indexes that may be respectively associated with multiple permutation matrices for various numbers of spatial layers (e.g., N) and various permutation levels (e.g., j). For example, the wireless communication standard may define a first set of permutation indexes respectively associated with a first set of possible permutation matrices for a first number of spatial layers and a first permutation level, and define a second set of permutation indexes respectively associated with a second set of possible permutation matrices for a second number of spatial layers and a second permutation level. In other words, the wireless communication standard may define different sets of permutation indexes respectively associated with different combinations of a number of spatial layers (e.g., N) and a permutation level (e.g., j).

In some examples, a first permutation matrix of the one or more permutation matrices may be associated with the first frequency subband of the transmission channel and a second permutation matrix of the one or more permutation matrices may be associated with the second frequency subband of the transmission channel. Additionally, the first permutation matrix and the second permutation matrix may be of a same permutation level. In such examples, the second information may include a set of bits that indicates an index from a set of permutation indexes that is associated with the first permutation matrix, and may include an additional bit that indicates whether the second permutation matrix is equivalent to the first permutation matrix.

In a sixth operation 630, the UE 120 may encode the GMD precoder information to include in a transmission of the first CSI report. As described elsewhere herein, the UE 120 may encode the first information (associated with the one or more Givens rotation matrices) separately from the second information (associated with the one or more permutation matrices).

In a seventh operation 635, the UE 120 may optionally generate SVD precoder information (e.g., the SVD precoder information 470). For example, the UE 120 may measure the one or more reference signals and perform SVD decomposition to determine a DFT basis (e.g., represented by B=[b₀, . . . , b_{L-1}]) and a set of elements of a unitary matrix V_{w}. In some examples, the network node 110 may use the DFT basis and the set of elements of the unitary matrix V_{w} to calculate an SVD precoder (e.g., the SVD precoder 315) to apply to the transmission channel (e.g., in accordance with Equation 3).

In an eighth operation 640, the UE 120 may optionally encode the SVD precoder information to include in a transmission of the second CSI report. As described elsewhere herein, the UE 120 may encode a quantized DFT basis and a set of quantized elements of the unitary matrix V_{w}.

In a ninth operation 645, the UE 120 may transmit, and the network node 110 may receive, the first CSI report that includes the GMD precoder information. In some examples, the first CSI report may optionally include information associated with a power loading matrix (e.g., the power loading matrix 320). For example, the first CSI report may include quantized information associated with the power loading matrix, where the power loading matrix may be associated with increasing power allocation across multiple spatial or frequency channels of the transmission channel based on respective channel conditions.

In a tenth operation 650, the UE 120 may optionally transmit, and the network node 110 may receive, the second CSI report that includes the SVD precoder information.

In some examples, one or more of the first CSI report or the second CSI report may optionally indicate one or more of an MCS and RI associated with the transmission channel.

In an eleventh operation 655, the network node 110 may optionally generate a UCD precoder (e.g., the UCD precoder 310) using one or more of the GMD precoder information (and optionally the power loading matrix information) included in the first CSI report or the SVD precoder information included in the second CSI report. For example, the network node 110 may construct the one or more Givens rotation matrices using the first information encoded in the first CSI report and construct the one or more permutation matrices using the second information encoded in the second CSI report. Accordingly, the network node 110 may calculate one or more GMD precoders respectively associated with one or more frequency subbands of the transmission channel in accordance with Equation 9. Additionally, if the first CSI report includes the quantized information associated with the power loading matrix, the network node 110 may use the quantized information to generate the power loading matrix. Alternatively, if the first CSI report does not include the quantized information associated with the power loading matrix, the network node 110 may assume equal power allocation across the subchannels of the transmission channel. Additionally, if the network node 110 receives the second CSI report, the network node 110 may calculate the SVD precoder in accordance with Equation 3. Alternatively, if the network node 110 does not receive the second CSI report, the network node 110 may continue using an SVD precoder used for a most recent downlink transmission to the UE 120. In accordance with determining the GMD precoder, the power loading matrix, and the SVD precoder, the network node 110 may calculate the UCD precoder in accordance with Equation 1. In examples where there are multiple GMD precoders respectively associated with multiple frequency subbands of the transmission channel, the network node 110 may calculate the multiple UCD precoders respectively associated with the multiple frequency subbands.

In a twelfth operation 660, the network node 110 may optionally transmit, and the UE 120 may receive, a wireless message that is precoded using the UCD precoder constructed from GMD precoder information and optionally the SVD precoder information.

As indicated above, FIG. 6 is provided as an example. Other examples may differ from what is described with regard to FIG. 6.

FIG. 7 is a diagram illustrating an example process 700 performed, for example, at UE or an apparatus of a UE. Example process 700 is an example where the apparatus or the UE (e.g., UE 120) performs operations associated with encoding of a precoder for spatial layer signal quality equivalence.

As shown in FIG. 7, in some aspects, process 700 may include receiving, from a network node, one or more reference signals associated with measurement of a signal quality associated with a transmission channel (block 710). For example, the UE (e.g., using communication manager 150 or reception component 902, depicted in FIG. 9) may receive, from a network node, one or more reference signals associated with measurement of a signal quality associated with a transmission channel, as described above.

As further shown in FIG. 7, in some aspects, process 700 may include transmitting, to the network node, a channel state information (CSI) report that includes precoder information indicative of a geometric mean decomposition (GMD) precoder associated with the transmission channel and includes first information associated with one or more Givens rotation matrices and second information associated with one or more permutation matrices (block 720). For example, the UE (e.g., using communication manager 150 or transmission component 904, depicted in FIG. 9) may transmit, to the network node, a channel state information (CSI) report that includes precoder information indicative of a geometric mean decomposition (GMD) precoder associated with the transmission channel and includes first information associated with one or more Givens rotation matrices and second information associated with one or more permutation matrices, as described above.

Process 700 may include additional aspects, such as any single aspect or any combination of aspects described below or in connection with one or more other processes described elsewhere herein.

In a first aspect, process 700 includes encoding the first information separately from the second information.

In a second aspect, alone or in combination with the first aspect, the first information includes one or more rotation angle values respectively associated with the one or more Givens rotation matrices.

In a third aspect, alone or in combination with one or more of the first and second aspects, the one or more rotation angle values include a first subset of rotation angle values associated with a first frequency subband of the transmission channel and include a second subset of rotation angles values associated with a second frequency subband of the transmission channel.

In a fourth aspect, alone or in combination with one or more of the first through third aspects, the second subset of rotation angle values are a subset of differential rotation angle values that is relative to the first subset of rotation angle values.

In a fifth aspect, alone or in combination with one or more of the first through fourth aspects, a permutation matrix of the one or more permutation matrices is associated with a set of permutation indexes that is in accordance with a factorial number system, the second information including a set of bits that indicates an index from the set of permutation indexes associated with the permutation matrix.

In a sixth aspect, alone or in combination with one or more of the first through fifth aspects, the set of permutation indexes includes a number of indexes that is in accordance with the factorial number system.

In a seventh aspect, alone or in combination with one or more of the first through sixth aspects, the factorial number system is associated with the set of permutation indexes that indicates a set of possible column-swapping patterns for a range of columns of a target matrix, and the range of columns spanning from a column of the target matrix associated with a permutation level of the permutation matrix to a last column of the target matrix.

In an eighth aspect, alone or in combination with one or more of the first through seventh aspects, the factorial number system is associated with the set of permutation indexes that indicates a set of possible column-swapping patterns for a range of columns of a target matrix a first pair of columns in the target matrix with a second pair of columns in the target matrix, the first pair of columns includes a first column associated with a permutation level of the permutation matrix and a second column that is directly after the first column, and the range of columns spanning from a column of the target matrix associated with the permutation level of the permutation matrix to a last column of the target matrix.

In a ninth aspect, alone or in combination with one or more of the first through eighth aspects, the factorial number system is associated with setting a lowest level permutation matrix of the one or more permutation matrices to a fixed column order.

In a tenth aspect, alone or in combination with one or more of the first through ninth aspects, a first permutation matrix of the one or more permutation matrices is associated with a first frequency subband of the transmission channel, and a second permutation matrix of the one or more permutation matrices is associated with a second frequency subband of the transmission channel, the first permutation matrix and the second permutation matrix being of a same permutation level.

In an eleventh aspect, alone or in combination with one or more of the first through tenth aspects, the second information includes a set of bits that indicates an index from a set of permutation indexes that is associated with the first permutation matrix and includes an additional bit that indicates whether the second permutation matrix is equivalent to the first permutation matrix.

In a twelfth aspect, alone or in combination with one or more of the first through eleventh aspects, the CSI report is a first CSI report, and a second CSI report is associated with information indicative of an SVD precoder.

In a thirteenth aspect, alone or in combination with one or more of the first through twelfth aspects, process 700 includes receiving, from the network node, configuration information that configures repetitions of the first CSI report in accordance with a first period and configures repetitions of the second CSI report in accordance with a second period that is greater than the first period.

In a fourteenth aspect, alone or in combination with one or more of the first through thirteenth aspects, process 700 includes receiving, from the network node, configuration information that configures the second CSI report in accordance with a period, and receiving, from the network node, control information that triggers an aperiodic transmission of the first CSI report.

In a fifteenth aspect, alone or in combination with one or more of the first through fourteenth aspects, the CSI report further includes information indicative of a power loading matrix.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with encoding of a precoder for spatial layer signal quality equivalence.

As shown in FIG. 8, in some aspects, process 800 may include sending one or more reference signals associated with measurement of a signal quality associated with a transmission channel (block 810). For example, the network node (e.g., using communication manager 150 or transmission component 1204, depicted in FIG. 12) may send one or more reference signals associated with measurement of a signal quality associated with a transmission channel, as described above.

As further shown in FIG. 8, in some aspects, process 800 may include obtaining a CSI report that includes precoder information indicative of a GMD precoder associated with the transmission channel and includes first information associated with one or more Givens rotation matrices and second information associated with one or more permutation matrices (block 820). For example, the network node (e.g., using communication manager 150 or reception component 1202, depicted in FIG. 12) may obtain a CSI report that includes precoder information indicative of a GMD precoder associated with the transmission channel and includes first information associated with one or more Givens rotation matrices and second information associated with one or more permutation matrices, as described above.

Process 800 may include additional aspects, such as any single aspect or any combination of aspects described below or in connection with one or more other processes described elsewhere herein.

In a first aspect, the first information is encoded separately from the second information.

In a second aspect, alone or in combination with the first aspect, the first information includes one or more rotation angle values respectively associated with the one or more Givens rotation matrices.

In a third aspect, alone or in combination with one or more of the first and second aspects, the one or more rotation angle values include a first subset of rotation angle values associated with a first frequency subband of the transmission channel and include a second subset of rotation angles values associated with a second frequency subband of the transmission channel.

In a fourth aspect, alone or in combination with one or more of the first through third aspects, the second subset of rotation angle values is a subset of differential rotation angle values that is relative to the first subset of rotation angle values.

In a fifth aspect, alone or in combination with one or more of the first through fourth aspects, a permutation matrix of the one or more permutation matrices is associated with a set of permutation indexes that is in accordance with a factorial number system, the second information including a set of bits that indicates an index from the set of permutation indexes associated with the permutation matrix.

In a sixth aspect, alone or in combination with one or more of the first through fifth aspects, the set of permutation indexes includes a number of indexes that is in accordance with the factorial number system.

In a seventh aspect, alone or in combination with one or more of the first through sixth aspects, the factorial number system is associated with the set of permutation indexes that indicates a set of possible column-swapping patterns for a range of columns of a target matrix, and the range of columns spanning from a column of the target matrix associated with a permutation level of the permutation matrix to a last column of the target matrix.

In an eighth aspect, alone or in combination with one or more of the first through seventh aspects, the factorial number system is associated with the set of permutation indexes that indicates a set of possible column-swapping patterns for a range of columns of a target matrix a first pair of columns in the target matrix with a second pair of columns in the target matrix, the first pair of columns includes a first column associated with a permutation level of the permutation matrix and a second column that is directly after the first column, and the range of columns spanning from a column of the target matrix associated with the permutation level of the permutation matrix to a last column of the target matrix.

In a ninth aspect, alone or in combination with one or more of the first through eighth aspects, the factorial number system is associated with setting a lowest level permutation matrix of the one or more permutation matrices to a fixed column order.

In a tenth aspect, alone or in combination with one or more of the first through ninth aspects, a first permutation matrix of the one or more permutation matrices is associated with a first frequency subband of the transmission channel and a second permutation matrix of the one or more permutation matrices is associated with a second frequency subband of the transmission channel, the first permutation matrix and the second permutation matrix being of a same permutation level.

In an eleventh aspect, alone or in combination with one or more of the first through tenth aspects, the second information includes a set of bits that indicates an index from a set of permutation indexes that is associated with the first permutation matrix and includes an additional bit that indicates whether the second permutation matrix is equivalent to the first permutation matrix.

In a twelfth aspect, alone or in combination with one or more of the first through eleventh aspects, the CSI report is a first CSI report, and a second CSI report is associated with information indicative of an SVD precoder.

In a thirteenth aspect, alone or in combination with one or more of the first through twelfth aspects, process 800 includes sending configuration information that configures repetitions of the first CSI report in accordance with a first period and configures repetitions of the second CSI report in accordance with a second period that is greater than the first period.

In a fourteenth aspect, alone or in combination with one or more of the first through thirteenth aspects, process 800 includes sending to the UE, configuration information that configures the second CSI report in accordance with a period, and sending to the UE, control information that triggers an aperiodic transmission of the first CSI report.

In a fifteenth aspect, alone or in combination with one or more of the first through fourteenth aspects, the CSI report further includes information indicative of a power loading matrix.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include an encoder component 908. The communication manager 150 may be included in, or implemented via, a processing system (for example, the processing system 140 described in connection with FIG. 1) of the UE.

In some aspects, the apparatus 900 may be configured to perform one or more operations described herein in connection with FIGS. 3 through 6. Additionally, or alternatively, the apparatus 900 may be configured to perform one or more processes described herein, such as process 700 of FIG. 7. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The reception component 902 may receive, from a network node, one or more reference signals associated with measurement of a signal quality associated with a transmission channel. The transmission component 904 may transmit, to the network node, a CSI report that includes precoder information indicative of a GMD precoder associated with the transmission channel and includes first information associated with one or more Givens rotation matrices and second information associated with one or more permutation matrices.

The encode component 908 may encode the first information separately from the second information.

The reception component 902 may receive, from the network node, configuration information that configures repetitions of the first CSI report in accordance with a first period and configures repetitions of the second CSI report in accordance with a second period that is greater than the first period.

The reception component 902 may receive, from the network node, configuration information that configures the second CSI report in accordance with a period.

The reception component 902 may receive, from the network node, control information that triggers an aperiodic transmission of the first CSI report.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

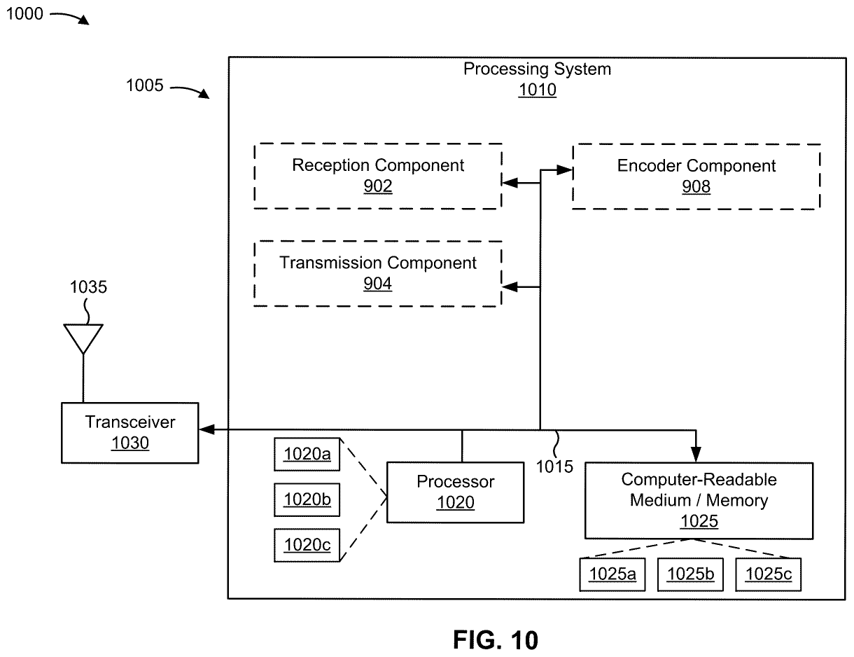

FIG. 10 is a diagram illustrating an example 1000 of a hardware implementation for an apparatus 1005 employing a processing system 1010. The apparatus 1005 may be a UE or may be at (e.g., included in) a UE. The processing system 1010 may be, or may be similar to, the processing system 140 of the UE 120 described in connection with FIG. 1.

The processing system 1010 may be implemented with a bus architecture, represented generally by the bus 1015. The bus 1015 may include any number of interconnecting buses and bridges depending on the specific application of the processing system 1010 and the overall design constraints. The bus 1015 links together various circuits including one or more processors or hardware components, represented by the processor 1020 (or processing circuitry), the illustrated components, and the computer-readable medium/memory (or memory circuitry) 1025. The processor 1020 may include multiple processors, such as processor 1020a, processor 1020b, and processor 1020c. The memory 1025 may include multiple memories, such as memory 1025a, memory 1025b, and memory 1025c. The bus 1015 may also link various other circuits, such as timing sources, peripherals, voltage regulators, or power management circuits.

The processing system 1010 may be coupled to one or more transceivers 1030. A transceiver 1030 is coupled to one or more antennas 1035. The transceiver 1030 provides a means for communicating with various other apparatuses over a transmission medium. The transceiver 1030 receives a signal from the one or more antennas 1035, extracts information from the received signal, and provides the extracted information to the processing system 1010, specifically the reception component 902. In addition, the transceiver 1030 receives information from the processing system 1010, specifically the transmission component 904, and generates a signal to be applied to the one or more antennas 1035 based at least in part on the received information.

The processing system 1010 includes one or more processors 1020 coupled to a computer-readable medium/memory 1025. A processor 1020 is responsible for general processing, including the execution of software stored on the computer-readable medium/memory 1025. The software, when executed by the processor 1020, causes the processing system 1010 to perform the various functions described herein for any particular apparatus. The computer-readable medium/memory 1025 may also be used for storing data that is manipulated by the processor 1020 when executing software. The processing system further includes at least one of the illustrated components. The components may be software modules running in the processor 1020, resident/stored in the computer readable medium/memory 1025, one or more hardware modules coupled to the processor 1020, or some combination thereof.

In some aspects, the processing system 1010 may be a component of the UE 120 or may be, may include, or may be included in the processing system 140 of the UE 120 described in connection with FIG. 1. In some aspects, the apparatus 1005 for wireless communication includes means for receiving, from a network node, one or more reference signals associated with measurement of a signal quality associated with a transmission channel, and transmitting, to the network node, a CSI report that includes precoder information indicative of a GMD precoder associated with the transmission channel and includes first information associated with one or more Givens rotation matrices and second information associated with one or more permutation matrices. The aforementioned means may be one or more of the aforementioned components of the apparatus 900 or the processing system 1010 of the apparatus 1005 configured to perform the functions recited by the aforementioned means. As described elsewhere herein, the processing system 1010 may include one or more components of the processing system 140 of the UE 120 described in connection with FIG. 1. In one configuration, the aforementioned means may be the processing system 140 or one or more components of the processing system 140 configured to perform the functions or operations recited herein.

FIG. 10 is provided as an example. Other examples may differ from what is described in connection with FIG. 10.

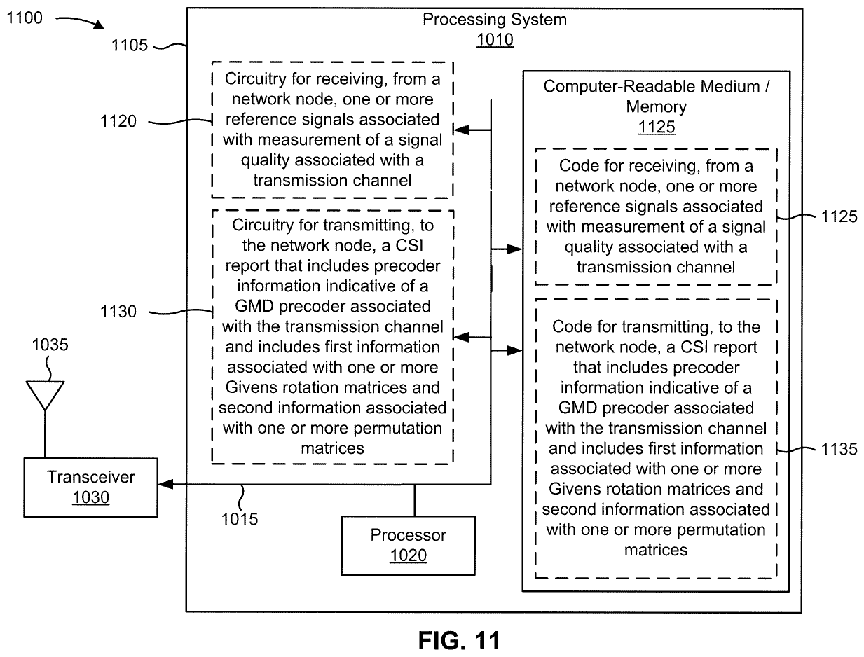

FIG. 11 is a diagram illustrating an example 1100 of an implementation of code and circuitry for an apparatus 1105. The apparatus 1105 may be a UE, or a UE may include the apparatus 1105.

As shown in FIG. 11, the apparatus 1105 may include circuitry for receiving, from a network node, one or more reference signals associated with measurement of a signal quality associated with a transmission channel (circuitry 1120). For example, the circuitry 1120 may enable the apparatus 1105 to receive, from a network node, one or more reference signals associated with measurement of a signal quality associated with a transmission channel.

As shown in FIG. 11, the apparatus 1105 may include, stored in computer-readable medium 1025, code for receiving, from a network node, one or more reference signals associated with measurement of a signal quality associated with a transmission channel (code 1125). For example, the code 1125, when executed by processor 1020, may cause processor 1020 to cause transceiver 1030 to receive, from a network node, one or more reference signals associated with measurement of a signal quality associated with a transmission channel.

As shown in FIG. 11, the apparatus 1105 may include circuitry for transmitting, to the network node, a CSI report that includes precoder information indicative of a GMD precoder associated with the transmission channel and includes first information associated with one or more Givens rotation matrices and second information associated with one or more permutation matrices (circuitry 1130). For example, the circuitry 1130 may enable the apparatus 1105 to transmit, to the network node, a CSI report that includes precoder information indicative of a GMD precoder associated with the transmission channel and includes first information associated with one or more Givens rotation matrices and second information associated with one or more permutation matrices.

As shown in FIG. 11, the apparatus 1105 may include, stored in computer-readable medium 1025, code for transmitting, to the network node, a CSI report that includes precoder information indicative of a GMD precoder associated with the transmission channel and includes first information associated with one or more Givens rotation matrices and second information associated with one or more permutation matrices (code 1135). For example, the code 1135, when executed by processor 1020, may cause processor 1020 to cause transceiver 1030 to transmit, to the network node, a CSI report that includes precoder information indicative of a GMD precoder associated with the transmission channel and includes first information associated with one or more Givens rotation matrices and second information associated with one or more permutation matrices.

FIG. 11 is provided as an example. Other examples may differ from what is described in connection with FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202 and a transmission component 1204, which may be in communication with one another (for example, via one or more buses or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 155. The communication manager 155 may include one or more of a decoder component 1208. The communication manager 155 may be included in, or implemented via, a processing system (for example, the processing system 145 described in connection with FIG. 1) of the network node.

In some aspects, the apparatus 1200 may be configured to perform one or more operations described herein in connection with FIGS. 3 through 6. Additionally, or alternatively, the apparatus 1200 may be configured to perform one or more processes described herein, such as process 800 of FIG. 8. In some aspects, the apparatus 1200 or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 or the transmission component 1204 may include or may be included in a network interface. The network interface may be configured to obtain or output signals for the apparatus 1200 via one or more communications links, such as a backhaul link, a midhaul link, or a fronthaul link.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 155 or the transmission component 1204 may send one or more reference signals associated with measurement of a signal quality associated with a transmission channel. The communication manager 155 or the reception component 1202 may obtain a CSI report that includes precoder information indicative of a GMD precoder associated with the transmission channel and includes first information associated with one or more Givens rotation matrices and second information associated with one or more permutation matrices.

The decoder component 1208 may decode the first information separately from the second information.

The communication manager 155 or the transmission component 1204 may send configuration information that configures repetitions of the first CSI report in accordance with a first period and configures repetitions of the second CSI report in accordance with a second period that is greater than the first period.

The communication manager 155 or the transmission component 1204 may send to the UE, configuration information that configures the second CSI report in accordance with a period.

The communication manager 155 or the transmission component 1204 may send to the UE, control information that triggers an aperiodic transmission of the first CSI report.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

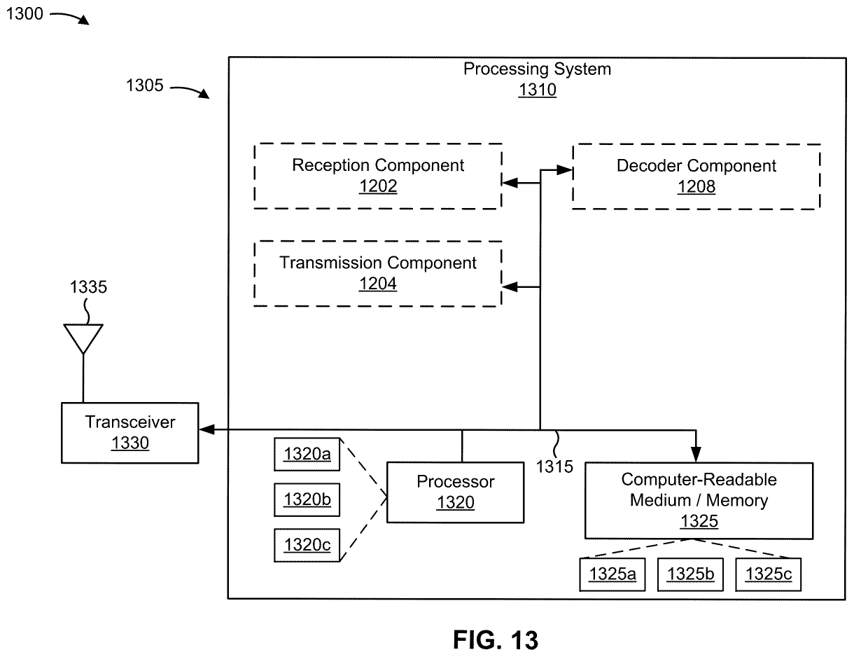

FIG. 13 is a diagram illustrating an example 1300 of a hardware implementation for an apparatus 1305 employing a processing system 1310. The apparatus 1305 may be a network node or may be at (e.g., included in) a network node. The processing system 1310 may be, or may be similar to, the processing system 145 of the network node 110 described in connection with FIG. 1.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors or hardware components, represented by the processor 1320 (or processing circuitry), the illustrated components, and the computer-readable medium/memory (or memory circuitry) 1325. The processor 1320 may include multiple processors, such as processor 1320a, processor 1320b, and processor 1320c. The memory 1325 may include multiple memories, such as memory 1325a, memory 1325b, and memory 1325c. The bus 1315 may also link various other circuits, such as timing sources, peripherals, voltage regulators, or power management circuits.

The processing system 1310 may be coupled to one or more transceivers 1330. A transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes one or more processors 1320 coupled to a computer-readable medium/memory 1325. A processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the network node 110 or may be, may include, or may be included in the processing system 145 of the network node 110 described in connection with FIG. 1. In some aspects, the apparatus 1305 for wireless communication includes means for sending one or more reference signals associated with measurement of a signal quality associated with a transmission channel, and obtaining a CSI report that includes precoder information indicative of a GMD precoder associated with the transmission channel and includes first information associated with one or more Givens rotation matrices and second information associated with one or more permutation matrices. The aforementioned means may be one or more of the aforementioned components of the apparatus 1200 or the processing system 1310 of the apparatus 1305 configured to perform the functions recited by the aforementioned means. As described elsewhere herein, the processing system 1310 may include one or more components of the processing system 145. In one configuration, the aforementioned means may be processing system 145 or one or more components of the processing system 145 configured to perform the functions or operations recited herein.

FIG. 13 is provided as an example. Other examples may differ from what is described in connection with FIG. 13.

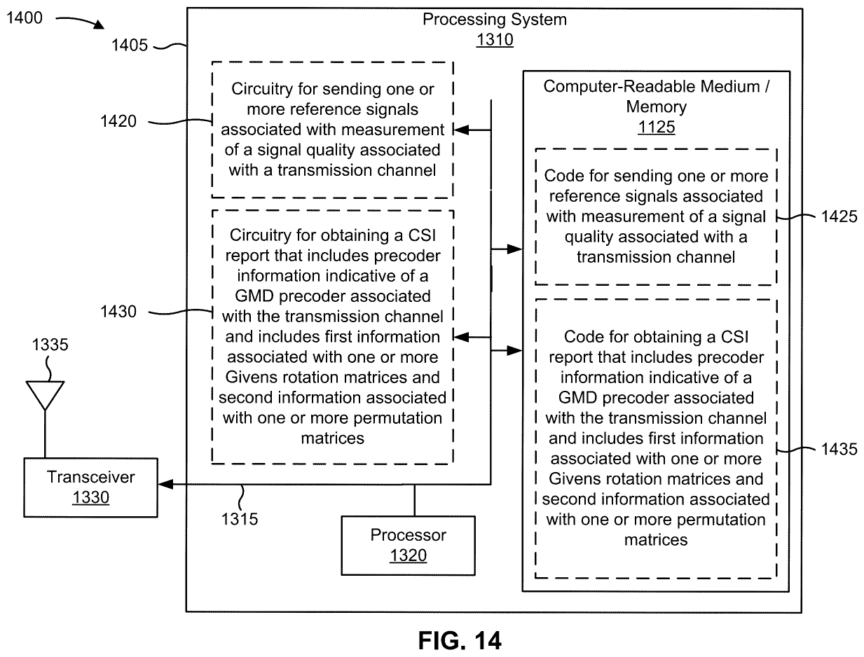

FIG. 14 is a diagram illustrating an example 1400 of an implementation of code and circuitry for an apparatus 1405. The apparatus 1405 may be a network node, or a network node may include the apparatus 1405.

As shown in FIG. 14, the apparatus 1405 may include circuitry for sending one or more reference signals associated with measurement of a signal quality associated with a transmission channel (circuitry 1420). For example, the circuitry 1420 may enable the apparatus 1405 to send one or more reference signals associated with measurement of a signal quality associated with a transmission channel.

As shown in FIG. 14, the apparatus 1405 may include, stored in computer-readable medium 1325, code for sending one or more reference signals associated with measurement of a signal quality associated with a transmission channel (code 1425). For example, the code 1425, when executed by processor 1320, may cause processor 1320 to send one or more reference signals associated with measurement of a signal quality associated with a transmission channel.

As shown in FIG. 14, the apparatus 1405 may include circuitry for obtaining a CSI report that includes precoder information indicative of a GMD precoder associated with the transmission channel and includes first information associated with one or more Givens rotation matrices and second information associated with one or more permutation matrices (circuitry 1430). For example, the circuitry 1430 may enable the apparatus 1405 to obtain a CSI report that includes precoder information indicative of a GMD precoder associated with the transmission channel and includes first information associated with one or more Givens rotation matrices and second information associated with one or more permutation matrices.

As shown in FIG. 14, the apparatus 1405 may include, stored in computer-readable medium 1325, code for obtaining a CSI report that includes precoder information indicative of a GMD precoder associated with the transmission channel and includes first information associated with one or more Givens rotation matrices and second information associated with one or more permutation matrices (code 1435). For example, the code 1435, when executed by processor 1320, may cause processor 1320 to obtain a CSI report that includes precoder information indicative of a GMD precoder associated with the transmission channel and includes first information associated with one or more Givens rotation matrices and second information associated with one or more permutation matrices.

FIG. 14 is provided as an example. Other examples may differ from what is described in connection with FIG. 14.

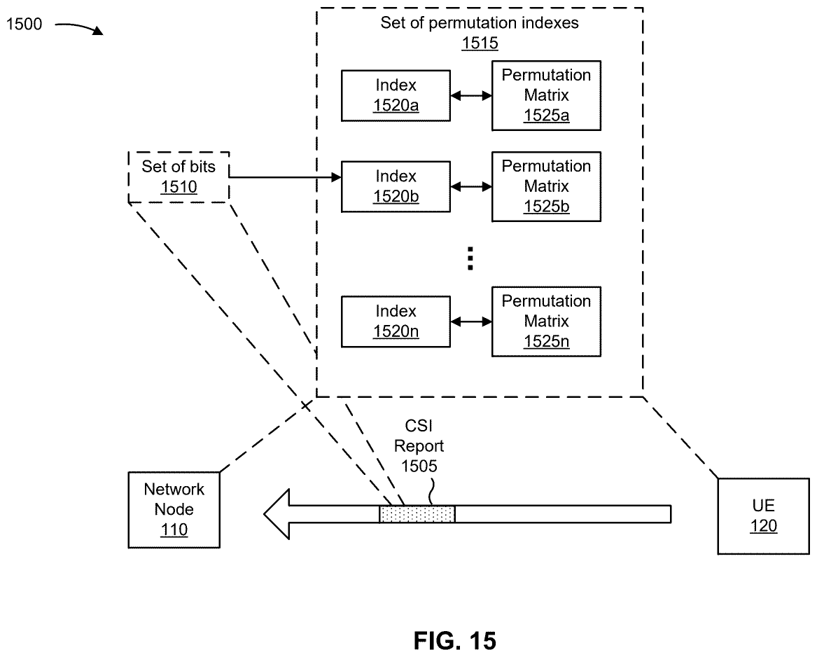

FIG. 15 is a diagram illustrating an example 1500 associated with a set of permutation indexes. In some instances, example 1500 may implement or be implemented by one or more aspects of FIGS. 1 through 5. For instance, FIG. 15 may illustrate wireless communications between the network node 110 and the UE 120. Additionally, the CSI report 1505 may be an example of the first CSI report 425 or the first CSI report 510 as described with reference to FIGS. 4 and 5. For instance, the CSI report 1505 may include a set of bits 1510 that may indicate the permutation index indication 455a.

As shown in FIG. 15, the set of bits 1510 included in the CSI report 1505 may be associated with a set of permutation indexes 1515 that includes multiple indexes (e.g., index 1520a, 1520b, and 1520n). Additionally, the set of permutation indexes 1515 may point to or be associated with a respective set of permutation matrices (e.g., the index 1520a points to the permutation matrix 1525a, the index 1520b points to the permutation matrix 1525b, and the index 1520n points to the permutation matrix 1525n). In some examples, the set of permutation indexes 1515 may be associated with the permutation matrices 420 described with reference to FIG. 4. For example, the set of permutation indexes 15515 may indicate the possible values that a permutation matrix may be for a value of N and j. As described elsewhere herein, the set of permutation indexes 1515 may be configured at one or more of the network node 110 and the UE 120.

As shown in FIG. 15, the set of bits 1510 point to the index 1520b which is associated with the permutation matrix 1525b. Accordingly, the UE may transmit, and the network node 110 may receive, the CSI report 1505 that includes the set of bits 1510. Based on the set of bits 1510 pointing to the index 1520b, the network node 110 may identify that the permutation matrix 1525b is associated with constructing an associated GMD precoder (e.g., in accordance with Equation 9). In some examples, the CSI report 1505 may include multiple sets of bits that point to multiple indexes that indicate multiple permutation matrices to use for constructing the associated GMD precoder.

FIG. 15 is provided as an example. Other examples may differ from what is described in connection with FIG. 15.

The following provides an overview of some Aspects of the present disclosure:

Aspect 1: A method of wireless communication performed at a user equipment (UE), comprising: receiving, from a network node, one or more reference signals associated with measurement of a signal quality associated with a transmission channel; and transmitting, to the network node, a channel state information (CSI) report that includes precoder information indicative of a geometric mean decomposition (GMD) precoder associated with the transmission channel and includes first information associated with one or more Givens rotation matrices and second information associated with one or more permutation matrices.

Aspect 2: The method of Aspect 1, further comprising: encoding the first information separately from the second information.

Aspect 3: The method of any of Aspects 1-2, wherein the first information includes one or more rotation angle values respectively associated with the one or more Givens rotation matrices.

Aspect 4: The method of Aspect 3, wherein the one or more rotation angle values include a first subset of rotation angle values associated with a first frequency subband of the transmission channel and include a second subset of rotation angles values associated with a second frequency subband of the transmission channel.

Aspect 5: The method of Aspect 4, wherein the second subset of rotation angle values are a subset of differential rotation angle values that is relative to the first subset of rotation angle values.

Aspect 6: The method of any of Aspects 1-5, wherein a permutation matrix of the one or more permutation matrices is associated with a set of permutation indexes that is in accordance with a factorial number system, the second information including a set of bits that indicates an index from the set of permutation indexes associated with the permutation matrix.

Aspect 7: The method of Aspect 6, wherein the set of permutation indexes includes a number of indexes that is in accordance with the factorial number system.

Aspect 8: The method of Aspect 6, wherein: the factorial number system is associated with the set of permutation indexes that indicates a set of possible column-swapping patterns for a range of columns of a target matrix, and the range of columns spanning from a column of the target matrix associated with a permutation level of the permutation matrix to a last column of the target matrix.

Aspect 9: The method of Aspect 6, wherein: the factorial number system is associated with the set of permutation indexes that indicates a set of possible column-swapping patterns for a range of columns of a target matrix a first pair of columns in the target matrix with a second pair of columns in the target matrix, the first pair of columns includes a first column associated with a permutation level of the permutation matrix and a second column that is directly after the first column, and the range of columns spanning from a column of the target matrix associated with the permutation level of the permutation matrix to a last column of the target matrix.

Aspect 10: The method of Aspect 6, wherein the factorial number system is associated with setting a lowest level permutation matrix of the one or more permutation matrices to a fixed column order.

Aspect 11: The method of any of Aspects 1-10, wherein a first permutation matrix of the one or more permutation matrices is associated with a first frequency subband of the transmission channel and a second permutation matrix of the one or more permutation matrices is associated with a second frequency subband of the transmission channel, the first permutation matrix and the second permutation matrix being of a same permutation level.

Aspect 12: The method of Aspect 11, wherein the second information includes a set of bits that indicates an index from a set of permutation indexes that is associated with the first permutation matrix and includes an additional bit that indicates whether the second permutation matrix is equivalent to the first permutation matrix.

Aspect 13: The method of any of Aspects 1-12, wherein the CSI report is a first CSI report, and wherein a second CSI report is associated with information indicative of a singular value decomposition (SVD) precoder.

Aspect 14: The method of Aspect 13, further comprising: receiving, from the network node, configuration information that configures repetitions of the first CSI report in accordance with a first period and configures repetitions of the second CSI report in accordance with a second period that is greater than the first period.

Aspect 15: The method of Aspect 13, further comprising: receiving, from the network node, configuration information that configures the second CSI report in accordance with a period; and receiving, from the network node, control information that triggers an aperiodic transmission of the first CSI report.

Aspect 16: The method of any of Aspects 1-15, wherein the CSI report further includes information indicative of a power loading matrix.

Aspect 17: A method of wireless communication performed at a network node, comprising: sending one or more reference signals associated with measurement of a signal quality associated with a transmission channel; and obtaining a channel state information (CSI) report that includes precoder information indicative of a geometric mean decomposition (GMD) precoder associated with the transmission channel and includes first information associated with one or more Givens rotation matrices and second information associated with one or more permutation matrices.

Aspect 18: The method of Aspect 17, wherein the first information is encoded separately from the second information.

Aspect 19: The method of any of Aspects 17-18, wherein the first information includes one or more rotation angle values respectively associated with the one or more Givens rotation matrices.

Aspect 20: The method of Aspect 19, wherein the one or more rotation angle values include a first subset of rotation angle values associated with a first frequency subband of the transmission channel and include a second subset of rotation angles values associated with a second frequency subband of the transmission channel.

Aspect 21: The method of Aspect 20, wherein the second subset of rotation angle values is a subset of differential rotation angle values that is relative to the first subset of rotation angle values.

Aspect 22: The method of any of Aspects 17-21, wherein a permutation matrix of the one or more permutation matrices is associated with a set of permutation indexes that is in accordance with a factorial number system, the second information including a set of bits that indicates an index from the set of permutation indexes associated with the permutation matrix.

Aspect 23: The method of Aspect 22, wherein the set of permutation indexes includes a number of indexes that is in accordance with the factorial number system.

Aspect 24: The method of Aspect 22, wherein: the factorial number system is associated with the set of permutation indexes that indicates a set of possible column-swapping patterns for a range of columns of a target matrix, and the range of columns spanning from a column of the target matrix associated with a permutation level of the permutation matrix to a last column of the target matrix.

Aspect 25: The method of Aspect 22, wherein: the factorial number system is associated with the set of permutation indexes that indicates a set of possible column-swapping patterns for a range of columns of a target matrix a first pair of columns in the target matrix with a second pair of columns in the target matrix, the first pair of columns includes a first column associated with a permutation level of the permutation matrix and a second column that is directly after the first column, and the range of columns spanning from a column of the target matrix associated with the permutation level of the permutation matrix to a last column of the target matrix.

Aspect 26: The method of Aspect 22, wherein the factorial number system is associated with setting a lowest level permutation matrix of the one or more permutation matrices to a fixed column order.

Aspect 27: The method of any of Aspects 17-26, wherein a first permutation matrix of the one or more permutation matrices is associated with a first frequency subband of the transmission channel and a second permutation matrix of the one or more permutation matrices is associated with a second frequency subband of the transmission channel, the first permutation matrix and the second permutation matrix being of a same permutation level.

Aspect 28: The method of Aspect 27, wherein the second information includes a set of bits that indicates an index from a set of permutation indexes that is associated with the first permutation matrix and includes an additional bit that indicates whether the second permutation matrix is equivalent to the first permutation matrix.

Aspect 29: The method of any of Aspects 17-28, wherein the CSI report is a first CSI report, and wherein a second CSI report is associated with information indicative of a singular value decomposition (SVD) precoder.

Aspect 30: The method of Aspect 29, further comprising: sending configuration information that configures repetitions of the first CSI report in accordance with a first period and configures repetitions of the second CSI report in accordance with a second period that is greater than the first period.

Aspect 31: The method of Aspect 29, further comprising: sending to the UE, configuration information that configures the second CSI report in accordance with a period; and sending to the UE, control information that triggers an aperiodic transmission of the first CSI report.

Aspect 32: The method of any of Aspects 17-31, wherein the CSI report further includes information indicative of a power loading matrix.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

Aspect 40: A device comprising a processing system that includes one or more processors and one or more code-storing memories coupled with the one or more processors, the processing system configured to cause the device to perform the method of one or more of Aspects 1-32.

Aspect 41: A device comprising a processing system that includes processor circuitry and code-storing memory circuitry, the processing system configured to cause the device to perform the method of one or more of Aspects 1-32.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of”′ or “one or more of”′ a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,” “’ or the equivalent in context, whatever it is that is “associated with ‘a,” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, one or more reference signals associated with measurement of a signal quality associated with a transmission channel; and
transmit, to the network node, a channel state information (CSI) report that includes precoder information indicative of a geometric mean decomposition (GMD) precoder associated with the transmission channel and includes first information associated with one or more Givens rotation matrices and second information associated with one or more permutation matrices.

2. The UE of claim 1, wherein the one or more processors are further configured to cause the UE to:
encode the first information separately from the second information.

3. The UE of claim 1, wherein the first information includes one or more rotation angle values respectively associated with the one or more Givens rotation matrices.

4. The UE of claim 3, wherein the one or more rotation angle values include a first subset of rotation angle values associated with a first frequency subband of the transmission channel and include a second subset of rotation angles values associated with a second frequency subband of the transmission channel.

5. The UE of claim 4, wherein the second subset of rotation angle values is a subset of differential rotation angle values that is relative to the first subset of rotation angle values.

6. The UE of claim 1, wherein a permutation matrix of the one or more permutation matrices is associated with a set of permutation indexes that is in accordance with a factorial number system, and wherein the second information includes a set of bits that indicates an index from the set of permutation indexes associated with the permutation matrix.

7. The UE of claim 6, wherein the set of permutation indexes includes a number of indexes that is in accordance with the factorial number system.

8. The UE of claim 6, wherein:
the factorial number system is associated with the set of permutation indexes that indicates a set of possible column-swapping patterns for a range of columns of a target matrix, and
the range of columns spans from a column of the target matrix associated with a permutation level of the permutation matrix to a last column of the target matrix.

9. The UE of claim 6, wherein:
the factorial number system is associated with the set of permutation indexes that indicates a set of possible column-swapping patterns for a range of columns of a target matrix to swap a first pair of columns in the target matrix with a second pair of columns in the target matrix,
the first pair of columns includes a first column associated with a permutation level of the permutation matrix and a second column that is directly after the first column, and the range of columns spans from a column of the target matrix associated with the permutation level of the permutation matrix to a last column of the target matrix.

10. The UE of claim 6, wherein the factorial number system is associated with a lowest level permutation matrix of the one or more permutation matrices that has a fixed column order.

11. The UE of claim 1, wherein a first permutation matrix of the one or more permutation matrices is associated with a first frequency subband of the transmission channel and a second permutation matrix of the one or more permutation matrices is associated with a second frequency subband of the transmission channel, wherein the first permutation matrix and the second permutation matrix are of a same permutation level.

12. The UE of claim 11, wherein the second information includes a set of bits that indicates an index from a set of permutation indexes that is associated with the first permutation matrix and includes an additional bit that indicates whether the second permutation matrix is equivalent to the first permutation matrix.

13. The UE of claim 1, wherein the CSI report is a first CSI report, and wherein a second CSI report is associated with information indicative of a singular value decomposition (SVD) precoder.

14. The UE of claim 13, wherein the one or more processors are further configured to cause the UE to:
receive, from the network node, configuration information that configures repetitions of the first CSI report in accordance with a first period and configures repetitions of the second CSI report in accordance with a second period that is greater than the first period.

15. The UE of claim 13, wherein the one or more processors are further configured to cause the UE to:
receive, from the network node, configuration information that configures the second CSI report in accordance with a period; and
receive, from the network node, control information that triggers an aperiodic transmission of the first CSI report.

16. The UE of claim 1, wherein the CSI report further includes information indicative of a power loading matrix.

17. A network node for wireless communication, comprising:
one or more memories; and
one or more processors, coupled to the one or more memories, configured to cause the network node to:
send one or more reference signals associated with measurement of a signal quality associated with a transmission channel; and
obtain a channel state information (CSI) report that includes precoder information indicative of a geometric mean decomposition (GMD) precoder associated with the transmission channel and includes first information associated with one or more Givens rotation matrices and second information associated with one or more permutation matrices.

18. The network node of claim 17, wherein the first information is encoded separately from the second information.

19. The network node of claim 17, wherein the first information includes one or more rotation angle values respectively associated with the one or more Givens rotation matrices.

20. The network node of claim 19, wherein the one or more rotation angle values include a first subset of rotation angle values associated with a first frequency subband of the transmission channel and include a second subset of rotation angles values associated with a second frequency subband of the transmission channel.

21. The network node of claim 20, wherein the second subset of rotation angle values is a subset of differential rotation angle values that is relative to the first subset of rotation angle values.

22. The network node of claim 17, wherein a permutation matrix of the one or more permutation matrices is associated with a set of permutation indexes that is in accordance with a factorial number system, and wherein the second information includes a set of bits that indicate an index from the set of permutation indexes associated with the permutation matrix.

23. The network node of claim 22, wherein the set of permutation indexes includes a number of indexes that is in accordance with the factorial number system.

24. The network node of claim 22, wherein:
the factorial number system is associated with the set of permutation indexes that indicates a set of possible column-swapping patterns for a range of columns of a target matrix, and
the range of columns that span from a column of the target matrix associated with a permutation level of the permutation matrix to a last column of the target matrix.

25. The network node of claim 22, wherein:
the factorial number system is associated with the set of permutation indexes that indicates a set of possible column-swapping patterns for a range of columns of a target matrix to swap a first pair of columns in the target matrix with a second pair of columns in the target matrix,
the first pair of columns includes a first column associated with a permutation level of the permutation matrix and a second column that is directly after the first column, and the range of columns span from a column of the target matrix associated with the permutation level of the permutation matrix to a last column of the target matrix.

26. The network node of claim 22, wherein the factorial number system is associated with a lowest level permutation matrix of the one or more permutation matrices that has a fixed column order.

27. The network node of claim 17, wherein a first permutation matrix of the one or more permutation matrices is associated with a first frequency subband of the transmission channel and a second permutation matrix of the one or more permutation matrices is associated with a second frequency subband of the transmission channel, wherein the first permutation matrix and the second permutation matrix are of a same permutation level.

28. The network node of claim 27, wherein the second information includes a set of bits that indicates an index from a set of permutation indexes that is associated with the first permutation matrix and includes an additional bit that indicates whether the second permutation matrix is equivalent to the first permutation matrix.

29. A method of wireless communication performed at a user equipment (UE), comprising:
receiving, from a network node, one or more reference signals associated with measurement of a signal quality associated with a transmission channel; and
transmitting, to the network node, a channel state information (CSI) report that includes precoder information indicative of a geometric mean decomposition (GMD) precoder associated with the transmission channel and includes first information associated with one or more Givens rotation matrices and second information associated with one or more permutation matrices.

30. A method of wireless communication performed at a network node, comprising:
sending one or more reference signals associated with measurement of a signal quality associated with a transmission channel; and
obtaining a channel state information (CSI) report that includes precoder information indicative of a geometric mean decomposition (GMD) precoder associated with the transmission channel and includes first information associated with one or more Givens rotation matrices and second information associated with one or more permutation matrices.
